(19) United States
(12) Patent Application Publication
(10) Pub. No.: US 2026/0131652 A1
(43) Pub. Date: May 14, 2026

(54) DRIVER ASSISTANCE SYSTEM, VEHICLE, RECORDING MEDIUM RECORDING COMPUTER PROGRAM, AND DRIVER ASSISTANCE METHOD

(71) Applicant: SUBARU CORPORATION, Tokyo (JP)

(72) Inventors: Mika SUZUKI, Tokyo (JP); Ryuichi SUMIKAWA, Tokyo (JP); Hideyuki TAKAO, Tokyo (JP)

(21) Appl. No.: 18/706,124

(22) PCT Filed: Sep. 21, 2022
(86) PCT No.: PCT/JP2022/035245

§ 371 Date: Apr. 30, 2024

(51) Int. Cl. B60K 35/26; B60K 35/29

(52) U.S. Cl. CPC B60K 35/26; B60K 35/29; B60K 35/28; B60W 50/14

(57) ABSTRACT

Provided is a driver assistance system or the like that makes it possible to assist a driver in taking a driving behavior more effectively by stimulating the auditory sense of the driver without executing complicated processing. A management server 20 repeatedly executes a behavior data acquisition process including acquiring behavior data of the driver based on a sound effect and a sound effect output control process including outputting the sound effect into the vehicle 1 while changing an output condition for outputting the sound effect into the vehicle 1. When the result of these processes satisfies a setting condition set in advance, the management server 20 executes an identification process including identifying the output condition corresponding to the result as an optimal output condition.

### TECHNICAL FIELD

The disclosure relates to a driver assistance system, a vehicle, a recording medium recording a computer program, and a driver assistance method.

### BACKGROUND ART

The technical level of a driving operation of a vehicle varies depending on a driver who drives the vehicle. The technical level of the driving operation affects ride comfort and traffic safety. Accordingly, various apparatuses have been proposed that determine a driving operation of a vehicle and notify the driver of the result of the driving operation determination and advice.

For example, Patent Literature 1 proposes a driver assistance apparatus that makes it possible to accurately determine a driving operation state, notify a driver of information about an overall evaluation of the driving operation state in current driving, and improve the driving operation technique in the next driving.

Specifically, such a driver assistance apparatus is configured to comprehensively evaluate the driving operation state in the current driving by determining whether the driving operation state is a flexible driving state or an unstable driving state based on the amount of change in an acceleration rate, a jerk, and determination criteria set using a vibration model.

### CITATION LIST

### Patent Literature

Patent Literature 1: Japanese Unexamined Patent Application Publication No. 2010-224762

### SUMMARY OF INVENTION

### Problem to be Solved by the Invention

However, the driver assistance apparatus described in Patent Literature 1 merely evaluates a series of driving operations executed during driving, and fails to appropriately assist a driver in taking a driving behavior.

The disclosure has been made in view of the above-described problems, and an object of the disclosure is to provide a driver assistance system or the like that makes it possible to assist a driver in taking a driving behavior more effectively by stimulating the auditory sense of the driver without executing complicated processing.

### Means for Solving the Problem

To address the above-described concern, a first aspect of the disclosure provides a driver assistance system configured to assist a driver who drives a vehicle. The driver assistance system includes one or more processors, and one or more memories communicably coupled to the one or more processors. The one or more processors are configured to: execute a data acquisition process including acquiring data indicating a behavior of the vehicle as behavior data while the vehicle is traveling at least in a predetermined section; execute, after the vehicle passes through the predetermined section, a sound effect output control process including performing control to stimulate an auditory sense of the driver by outputting a sound effect corresponding to behavior stability retrieved from the behavior data obtained in the predetermined section; execute the data acquisition process and the sound effect output control process repeatedly while changing an output condition of the sound effect; and execute, when a result of the data acquisition process and the sound effect output control process repeatedly executed satisfies a setting condition set in advance, an identification process including identifying the output condition corresponding to the result as an optimal output condition.

To address the above-described concern, a second aspect of the disclosure provides a vehicle including a driver assistance apparatus that assists driving of the vehicle. The driver assistance apparatus is configured to: execute a data acquisition process including acquiring data indicating a behavior of the vehicle as behavior data while the vehicle is traveling at least in a predetermined section; execute, after the vehicle passes through the predetermined section, a sound effect output control process including performing control to stimulate an auditory sense of the driver by outputting a sound effect corresponding to behavior stability of retrieved from the behavior data obtained in the predetermined section; execute the data acquisition process and the sound effect output control process repeatedly while changing an output condition of the sound effect; and execute, when a result of the data acquisition process and the sound effect output control process repeatedly executed satisfies a setting condition set in advance, an identification process including identifying the output condition corresponding to the result as an optimal output condition.

To address the above-described concern, a third aspect of the disclosure provides a recording medium recording a computer program to be applied to a driver assistance system that assists driving of a vehicle. The computer program causes a computer to execute a data acquisition process including acquiring data indicating a behavior of the vehicle as behavior data while the vehicle is traveling at least in a predetermined section; execute, after the vehicle passes through the predetermined section, a sound effect output control process including performing control to stimulate an auditory sense of a driver by outputting a sound effect corresponding to behavior stability retrieved from the behavior data obtained in the predetermined section; execute the data acquisition process and the sound effect output control process repeatedly while changing an output condition of the sound effect; and execute, when a result of the data acquisition process and the sound effect output control process repeatedly executed satisfies a setting condition set in advance, an identification process including identifying the output condition corresponding to the result as an optimal output condition.

To address the above-described concern, a fourth aspect of the disclosure provides a driver assistance method of assisting driving of a vehicle. The driver assistance method includes acquiring data indicating a behavior of the vehicle as behavior data while the vehicle is traveling at least in a predetermined section; executing, after the vehicle passes through the predetermined section, a sound effect output control process including performing control to stimulate an auditory sense of the driver by outputting a sound effect corresponding to behavior stability retrieved from the behavior data obtained in the predetermined section; executing the data acquisition process and the sound effect output control process repeatedly while changing an output condition of the sound effect; and executing, when a result of the data acquisition process and the sound effect output control process repeatedly executed satisfies a setting condition set in advance, an identification process including identifying the output condition corresponding to the result as an optimal output condition.

### Effects of the Invention

According to the driver assistance system or the like of the disclosure having the configurations described above, it is possible to assist a driver in taking a driving behavior more effectively by stimulating the auditory sense of the driver without executing complicated processing.

### BRIEF DESCRIPTION OF DRAWINGS

FIG. 1 is an exemplary system configuration diagram illustrating a system configuration of a driver assistance network system for vehicles according to a first embodiment of the disclosure.

FIG. 2 is a schematic diagram illustrating a configuration example of a vehicle provided with an information processing system according to the first embodiment.

FIG. 3 is a block diagram illustrating a configuration example of the information processing system according to the first embodiment.

FIG. 4 is a block diagram illustrating a configuration example of a management server according to the first embodiment.

FIG. 5 is a diagram for describing a sound effect optimization output condition identification process according to the first embodiment.

FIG. 6 is a table illustrating an example of driver data stored in a driver data memory unit according to the first embodiment.

FIG. 7 is a table illustrating an example of group data stored in the driver data memory unit according to the first embodiment.

FIG. 8 is a diagram for describing a sound effect output control process including a process for setting sound effect output control data for behavior analysis to be executed by a data analysis unit according to the first embodiment.

FIG. 9 is a diagram for describing an output condition identification process including resetting the sound effect output control data for behavior analysis to be executed by the data analysis unit according to the first embodiment.

FIG. 10 is a flowchart of the sound effect optimization output condition identification process to be executed by the management server according to the first embodiment.

FIG. 11 is a flowchart of an operation of the sound effect optimization output condition identification process to be executed by the management server according to the first embodiment.

FIG. 12 is a flowchart of an operation in the vehicle 1 relating to the sound effect optimization output condition identification process to be executed by the information processing system according to the first embodiment.

FIG. 13 is a diagram illustrating a sound effect optimization output condition identification process according to a second embodiment of the disclosure.

FIG. 14 is a flowchart of the sound effect optimization output condition identification process to be executed by the management server according to the second embodiment.

FIG. 15 is a flowchart of an operation of the sound effect optimization output condition identification process to be performed by the management server according to the second embodiment.

### MODES FOR CARRYING OUT THE INVENTION

### [A] Features of Embodiments of the Disclosure

(1) According to an embodiment of the disclosure, a driver assistance system that assists a driver who drives a vehicle includes one or more processors, and one or more memories communicably coupled to the one or more processors. The one or more processors execute a data acquisition process for acquiring data indicating a behavior of the vehicle as behavior data while the vehicle is traveling at least in a predetermined section; execute, after the vehicle passes through the predetermined section, a sound effect output control process for performing control to stimulate an auditory sense of the driver by outputting a sound effect corresponding to behavior stability retrieved from the behavior data obtained in the predetermined section; execute the data acquisition process and the sound effect output control process repeatedly while changing an output condition of the sound effect; and execute, when a result of the data acquisition process and the sound effect output control process repeatedly executed satisfies a setting condition set in advance, an identification process for identifying the output condition corresponding to the result as an optimal output condition.

Note that the embodiments of the disclosure are implementable by a driver assistance apparatus mounted in a vehicle configured to execute the processes described above, a recording medium recording a computer program for executing the processes described above, or a driver assistance method involving execution of the processes described above.

With such a configuration, the driver assistance system or the like of the disclosure makes it possible to automatically identify a sound effect output condition, such as an output timing, a sound type, or a tone color of the sound effect optimal for the driver to enhance the behavior stability. Accordingly, the driver assistance system or the like of the disclosure makes it possible to appropriately stimulate the auditory sense of the driver to enhance the behavior stability by simply providing the driver with the sound effect output condition automatically identified. As a result, the driver assistance system or the like of the disclosure makes it possible to assist the driver in taking a driving behavior for stabilizing a vehicle behavior more effectively without executing complicated processing

The term “predetermined section” refers to a section of distance or time through which the vehicle passes through, such as a section partitioned by a predetermined traveling distance, a section partitioned by a predetermined traveling time, or a section partitioned at each reference point such as an intersection provided with a traffic light, for example.

The term “vehicle behavior” refers to a movement (operation) of a vehicle including a stopping behavior, an accelerating behavior, a decelerating behavior, a constant speed traveling behavior, and a turning behavior of the vehicle based on a steering operation, an accelerator operation, or a braking operation of the driver, for example. The term “behavior stability” refers to the degree of change in operation or state of the vehicle behavior. As the behavior stability increases, the operational change in the vehicle behavior decreases or becomes smoother.

When the driver assistance system is implemented by a cloud server that executes various processes, for example, the term “sound effect output control process” refers to a process for controlling a sound effect output into the vehicle that involves, for example, providing or setting the output condition. In addition, when the driver assistance system is implemented in a stand-alone manner by the information processor mounted in the vehicle, for example, the term “sound effect output control process” refers to the output control itself of outputting a sound effect directly into the vehicle.

The term “output condition” refers to the output timing, the number of times of outputs, a tone color (interval (pitch), intensity, the number of tones, the volume, or the tempo of the sound effect, for example.

Examples of the sound effect include a medal acquisition sound, an applause sound, a fireworks sound, and a cord composed of a plurality of sounds having different pitches or tones. In particular, the sound effect is preferably a sound that stabilize a vehicle behavior or a sound that makes the driver feel more fulfilled or comfortable as the stability of the vehicle behavior increases. The sound effect may be a sound that makes the driver feel more negative as the stability of the vehicle behavior decreases. Note that the sound effect of the present embodiment varies depending on the output condition described above.

The term “setting condition” refers to conditions including, for example, a condition for increasing the behavior stability, a condition for decreasing the behavior stability, and a condition based on a stable index, such as an angular velocity, a jerk, an angular velocity, or an angular acceleration rate of the vehicle.

(2) According to an embodiment of the disclosure, the one or more processors may execute an information acquisition process for acquiring driver characteristic information indicating characteristics of the driver, and may identify the optimal output condition based on a predetermined one of the characteristics of the driver in the identification process.

With such a configuration, the driver assistance system or the like of the disclosure makes it possible to automatically identify the sound effect output condition based on whether the driver is a beginner driver or a skilled driver, or the difference in individual ability, such as the difference in reaction speed in response to the sound effect or the difference in ability to learn a driving skill based on the sound effect, for example.

The term “driver characteristic” refers to a driving characteristic intended by the driver when driving the vehicle or a characteristic relating to the driving ability of the driver. In particular, the driving characteristic includes a driving characteristic provided by an accelerating operation, a braking operation, or a steering operation of the driver, for example. The characteristic relating to the driving ability includes the difference in reaction speed in response to a sound, the difference in ability to learn driving, and the like. In addition, the term “information acquisition process” refers to acquiring information on an accelerator operation, a braking operation, or a steering operation of the vehicle.

(3) According to an embodiment of the disclosure, the one or more processors may execute an information acquisition process for acquiring information on traveling environments of the vehicle, and identify the optimal output condition based on a predetermined one of the traveling environments in the identification process.

With such a configuration, the driver assistance system of the disclosure or the like makes it possible to automatically identify the sound effect output condition for stabilizing the behavior of the vehicle in accordance with the traveling environments.

The term “traveling environment” refers to a traffic environment such as an environment in which many pedestrians or bicycles are present, an environment in which oncoming vehicles or obstacles are present, a heavy traffic environment, or an environment with a high danger of accident; a road environment such as a school road in a school time zone, a road shape, or a large or narrow road width; and weather such as sunny, rainfall, or snowfall weather. The “information acquisition process” includes a process for acquiring position information of the vehicle, information on a traveling area and time, or surrounding condition of the vehicle in place of the information regarding the traveling environment.

(4) According to an embodiment of the disclosure, the output condition to be identified by the one or more processors may include one or more of an output timing, the number of times of outputs, a tone color, a volume, a length, and a tempo of the sound effect.

With such a configuration, the driver assistance system of the disclosure or the like makes it possible to automatically identify the output condition such as the output timing, the number of times of outputs, the tone color, the volume, the length, or the tempo of the sound effect.

The term “length” refers to a length of reproducing time, an the term “tempo” refers to the length of time necessary to reproduce (output) a single sequence of sounds when the sound effect includes a plurality of sequences of sounds.

(5) According to an embodiment of the disclosure, the one or more processors may stop the sound effect output control process and the data acquisition process in the identification process when the result of the data acquisition process and the sound effect output control process repeatedly executed is determined to satisfy the setting condition set in advance; execute, when the sound effect output control process and the data acquisition process are stopped, an output condition fixing control process for executing the control to stimulate the auditory sense of the driver with fixing the output condition of the sound effect to the optimal output condition identified; acquire the behavior data based on the output condition fixing control process; and restart the identification process when the behavior stability retrieved from the behavior data acquired satisfies a given particular output condition.

With such a configuration, the driver assistance system or the like of the disclosure makes it possible to reset the optimization output condition when a more optimal output condition seems to be able to be set. This enables updating of the sound effect output condition as needed. Accordingly, during the driver assistance, the driver assistance system or the like of the disclosure makes it possible to maintain the sound effect output condition for always providing vehicle stability optimal for the driver.

The term “first identification output condition” includes a condition that a change in the behavior stability is no longer detected or a condition that the change becomes smaller than a predetermined value. Here, the condition that the change in the behavior stability is no longer detected refers to the condition that the change in the behavior stability reaches a limit value, and the condition that the change becomes smaller than the predetermined value refers to the condition that the change reaches a value near the limit value, for example.

The term “second identification output condition” includes a condition that a possibility of further increasing the vehicle behavior stability is generated, such as a condition that the behavior stability retrieved from the behavior stability reference data provided from the outside is higher than the behavior stability of the vehicle, for example.

(6) According to an embodiment of the disclosure, when the identification process is restarted, the one or more processors may use a setting condition different from the setting condition set before restarting the identification process.

With such a configuration, the driver assistance system or the like of the disclosure makes it possible to maintain the sound effect output condition for always providing vehicle stability optimal for the driver.

(7) According to an embodiment of the disclosure, when the number of pieces of the behavior data acquired in the data acquisition process is insufficient, the one or more processors may execute control to acquire additional pieces of behavior data or a process for correcting the behavior stability retrieved from the behavior data that has been already acquired.

With such a configuration, even when the number of the drivers that collect the behavior data is small (e.g., when one driver collects the behavior data), the driver assistance system or the like of the disclosure makes it possible to acquire additional pieces of the behavior data or perform correction of the behavior data to compensate for the lack of number of the drivers. Accordingly, even when the number of drivers is small, the driver assistance system of the disclosure makes it possible to set the optimal sound effect output condition.

### [B] Details of Embodiments of the Disclosure

In the following, some preferred embodiments of the disclosure are described in detail with reference to the accompanying drawings. Note that, throughout the specification and the drawings, elements having substantially the same functional configurations are denoted by the same reference numerals to omit duplicate description.

### [B] First Embodiment

### [B1.1] Driver Assistance Network System

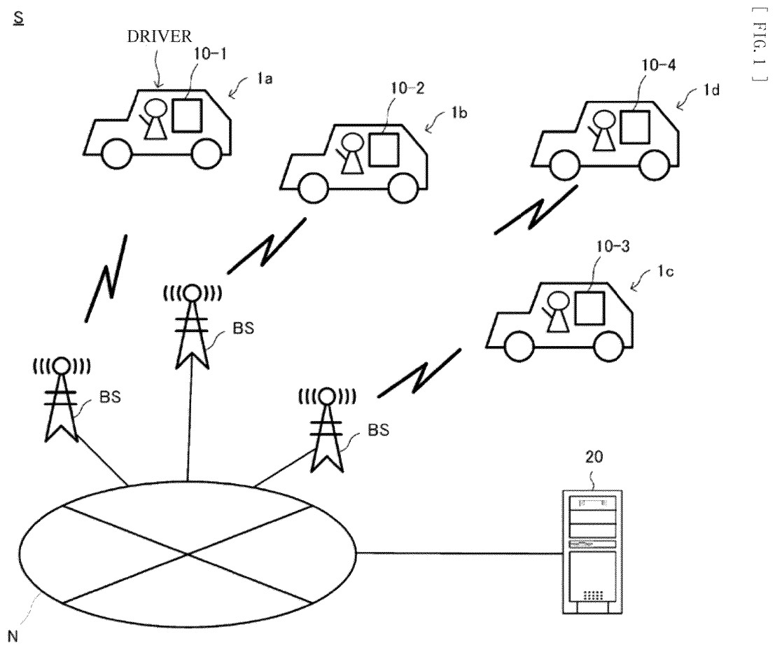

First, a driver assistance network system S according to a first embodiment is schematically described with reference to FIG. 1. FIG. 1 is a system configuration diagram illustrating a configuration of the driver assistance network system S for vehicles 1 according to the first embodiment.

To prevent the drawings from being complicated, FIG. 1 illustrates only some of the vehicles 1 (each including an information processing system 10) driven by respective drivers. That is, the driver assistance network system S actually increase a larger number of vehicles 1 than those illustrated in FIG. 1.

The driver assistance network system S according to the first embodiment collects data indicating behaviors of the vehicles 1 obtained based on driving operations caused by auditory stimulation on the drivers (hereinafter referred to as “behavior data”). The driver assistance network system S is a system that identifies an optimal condition for outputting a sound effect to stabilize the behavior of the vehicle 1 (hereinafter referred to as an “optimization output condition”) based on the collected behavior data. That is, the driver assistance network system S according to the first embodiment is configured to execute an identification process for identifying the optimal condition for outputting a sound effect to stabilize the behavior of the vehicle 1 based on auditory stimulation on the drivers (hereinafter referred to as a “sound effect optimization output condition identification process”).

As illustrated in FIG. 1, the driver assistance network system S according to the first embodiment includes the information processing systems 10 mounted in the respective vehicles 1 subjected to the driver assistance, and a management server 20 that performs the driver assistance in conjunction with the information processing system 10.

The vehicle 1 is a four-wheeled vehicle, a two-wheeled vehicle, or another vehicle to be driven by a driver, and is not particularly limited as long as being an object movable at a predetermined moving speed.

The information processing system 10 is an apparatus mounted in each of the vehicles 1. The information processing system 10 is coupled to the management server 20 via a network such as the Internet or a public network. Specifically, the information processing system 10 is configured to establish wireless or wired communication with the management server 20 via a base station BS to send and receive various kinds of data. Further, the information processing system 10 is a system that executes a process relating to the sound effect optimization output condition identification process in the vehicle 1 in conjunction with the management server 20.

Specifically, the information processing system 10 is configured to receive data on the sound effect output condition (hereinafter referred to as “output condition data”) set in the management server 20, and output a predetermined sound effect based on the received output condition. In addition, while the sound effect is outputted, the information processing system 10 collects data on a behavior of the vehicle 1 based on a driving operation of the driver (hereinafter referred to as “behavior data”), and provides the collected behavior data to the management server 20.

The management server 20 is an apparatus communicably coupled to the information processing system 10 mounted in each vehicle 1 using cloud computing technology via a network. The management server 20 of the present embodiment may include one server (apparatus or processor) or may include multiple servers (apparatuses and processors). The management server 20 includes various databases (in a broad sense, storage devices or a memories) in which various kinds of information are stored. The various kinds of information are used for the driver assistance for each driver, including the sound effect optimization output condition identification process.

The management server 20 of the present embodiment may access a database (in a broad sense, a storage device or a memory) coupled to the management server 20 via a network, or another server apparatus (not illustrated) that manages, for example, a database (in a broad sense, a storage device or a memory).

The management server 20 is configured to execute processes relating to the sound effect optimization output condition identification process, including a process for providing data to the information processing system 10 and a process for controlling the data, in conjunction with the information processing system 10 of each vehicle 1 in order to execute the driver assistance more effectively based on the auditory stimulation.

In particular, the management server 20 is configured to provide the output conditions of sound effects to be received by the drivers to the respective information processing systems 10 while changing the output conditions, to thereby acquire the behavior data of the drivers based on the respective output conditions from the respective information processing systems 10 of the vehicles 1. Further, the management server 20 is configured to automatically identify, based on the acquired behavior data of each vehicle 1 based on the output condition, the sound effect optimization output condition that increases the behavior stability of the vehicle 1 driven by the driver subjected to the driver assistance. Further, the management server 20 is configured to provide the identified optimization output condition to the relevant information processing system 10 of the vehicle 1 in order to output a predetermined sound effect into the vehicle 1 driven by the driver.

According to the present embodiment, examples of the sound effect include a medal acquisition sound, an applause sound, a fireworks sound, and a chord including a plurality of sounds having different pitches or tone colors, Further, examples of the sound effect output condition include the output timing, the number of outputs, the tone color (pitch, intensity, the number of tones), the volume, the length, or the tempo of the sound effect, or a combination of two or more thereof.

### [B1.2] Vehicle

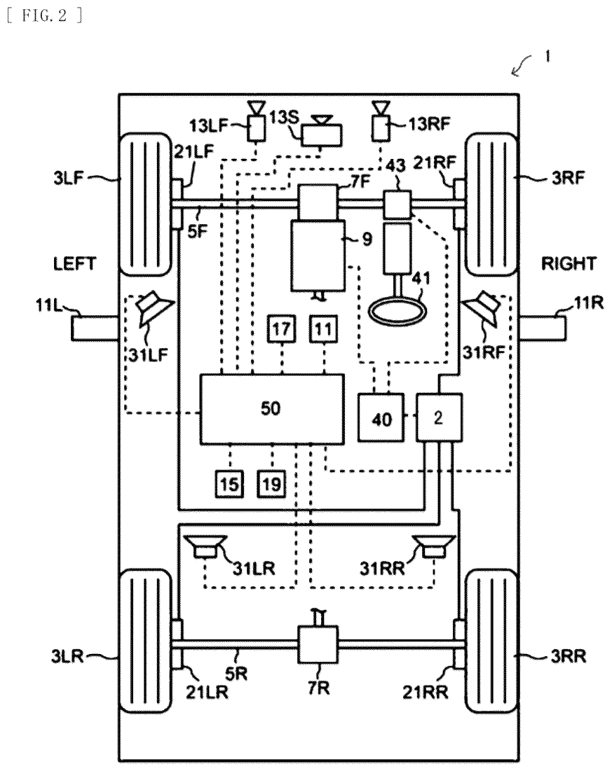

Next, an example of an overall configuration of a vehicle of the present embodiment is described with reference to FIG. 2. FIG. 2 is a schematic diagram illustrating a configuration example of the vehicle 1 including the information processing system 10 of the present embodiment.

As illustrated in FIG. 2, the vehicle 1 is configured as a four-wheeled vehicle that transmits drive torque of the vehicle outputted from a drive power source 9, which generates the drive torque, to a left-front wheel 3LF, a right-front wheel 3RF, a left-rear wheel 3LR, and a right-rear wheel 3RR (hereinafter, collectively referred to as “wheels 3” when no particular distinction is required). The drive power source 9 may be an internal combustion engine such as a gasoline engine or a diesel engine, may be a drive motor, or may include both an internal combustion engine and a drive motor.

Note that the vehicle 1 may be an electric vehicle including two drive motors, i.e., a front-wheel drive motor and a rear-wheel drive motor, or may be an electric vehicle including drive motors corresponding to the respective wheels 3, for example. When the vehicle 1 is an electric vehicle or a hybrid electric vehicle, the vehicle 1 includes a power generator such as a secondary battery that stores electric power to be supplied to the drive motor, a motor that generates electric power to be charged in a battery, or a fuel cell.

The vehicle 1 includes the drive power source 9, an electric steering device 43, and a brake hydraulic control unit 2, as devices used for controlling driving of the vehicle 1. The drive power source 9 outputs drive torque to be transmitted to a front-wheel drive shaft 5F and a rear-wheel drive shaft 5R via a non-illustrated transmission, a front-wheel differential mechanism 7F, and a rear-wheel differential mechanism 7R. Driving of the drive power source 9 and driving of the transmission are controlled by a vehicle control apparatus 40 including one or more electronic control units (ECUs).

The front-wheel drive shaft 5F is provided with an electric steering device 43. The electric steering device 43 includes a non-illustrated electric motor and a non-illustrated gear mechanism, and adjusts steering angles of the left-front wheel 3LF and the right-front wheel 3RF under the control of the vehicle control apparatus 40. During manual driving, the vehicle control apparatus 40 controls the electric steering device 43 based on a steering angle of a steering wheel 41 operated by the driver. The electric steering device 43 may be a hydraulic power steering device.

The vehicle 1 includes a brake system configured as a hydraulic brake system. The brake hydraulic control unit 2 adjusts hydraulic pressure to be supplied to brake calipers 21LF, 21RF, 21LR, and 21RR (hereinafter, collectively referred to as “brake calipers 21” when no particular distinction is required) provided to the left-front wheel 3LF, the right-front wheel 3RF, the left-rear wheel 3LR, and the right-rear wheel 3RR, respectively, to generate a braking force. Driving of the brake hydraulic control unit 2 is controlled by the vehicle control apparatus 40. When the vehicle 1 is an electric vehicle or a hybrid electric vehicle, the brake hydraulic control unit 2 is used in combination with regenerative braking by the drive motor.

The vehicle control apparatus 40 includes a drive power source 9 that outputs drive torque of the vehicle 1, an electric steering device 43 that controls steering angles of the steering wheel 41 or steered wheels, and one or more electronic control units that control driving of the brake hydraulic control unit 2 that controls the braking force of the vehicle 1. The vehicle control apparatus 40 may have a function of controlling driving of the transmission that converts an output outputted from the drive power source 9 and transmits the converted output to the wheels 3. During manual driving of the vehicle 1, the vehicle control apparatus 40 acquires information on the amount of a driving operation performed by the driver, and controls driving of the drive power source 9 that outputs drive torque of the vehicle 1, driving of the electric steering device 43 that controls the steering angles of the steering wheel 41 or the steered wheels, and driving of the brake hydraulic control unit 2 that controls the braking force of the vehicle 1.

### [B1.3] Information Processing System

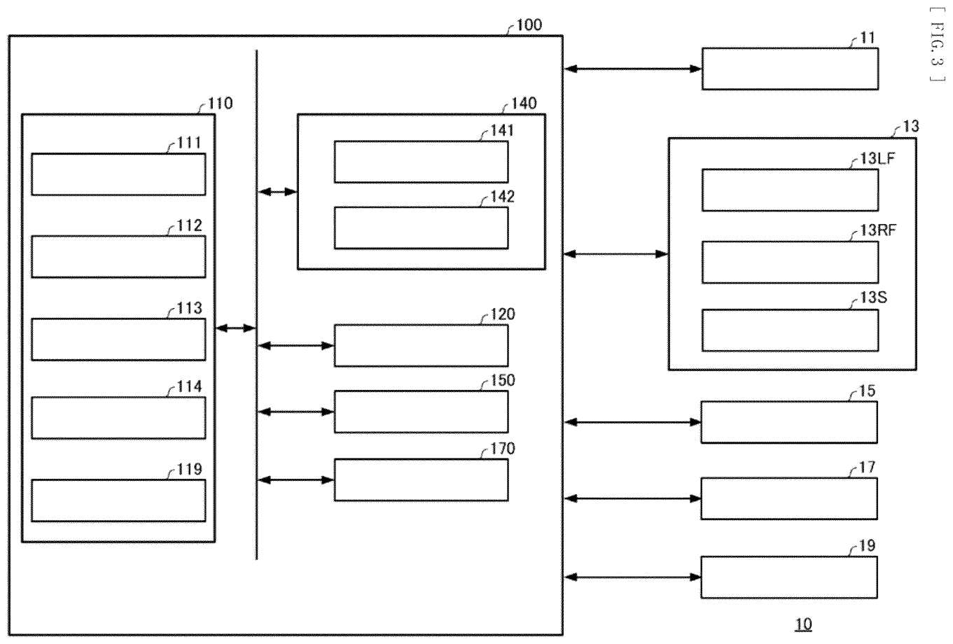

Next, a configuration example of the information processing system 10 mounted in the vehicle 1 of the present embodiment is described with reference to FIG. 3. FIG. 3 is a block diagram illustrating a configuration example of the information processing system 10 according to the present embodiment.

### (Outline of Information Processing System)

While the vehicle 1 is traveling, the information processing system 10 acquires the data indicating the behavior of the vehicle 1 in conjunction with the management server 20, and executes a process for outputting a sound for stimulating the auditory sense of the driver to stabilize the behavior of the vehicle 1. Since the states of a steering operation, an accelerator operation, and a brake operation of the driver are reflected on the behavior of the vehicle 1, the information processing system 10 is configured to make the driver intuitively recognize an evaluation of his/her driving operation state in real time.

As illustrated in FIG. 3, the information processing system 10 further includes a vehicle behavior measurement device 11, a vehicle surrounding condition detector 13, a weather information detector 15, a vehicle position information detector 17, a sound output device 19, and an information processing apparatus 100. The vehicle behavior measurement device Il, the vehicle surrounding condition detector 13, the weather information detector 15, the vehicle position information detector 17, and the sound output device 19 are communicably coupled to the information processing apparatus 100 via a communication bus such as a dedicated line or a controller area network (CAN).

The information processing system 10 of the present embodiment is preferably configured to operate in conjunction with a navigation system (not illustrated) mounted in the vehicle 1, or has a navigation system function including the vehicle position information detector 17; however, the information processing system 10 is not limited thereto.

### (Vehicle Behavior Measurement Device)

The vehicle behavior measurement device 11 is a device that measures the data indicating the behavior of the vehicle 1. The vehicle behavior measurement device Il includes one or more of a vehicle speed sensor, an acceleration sensor, and an angular velocity sensor, for example.

For instance, the vehicle speed sensor detects a rotational speed of a drive shaft of the vehicle 1. The acceleration sensor detects at least a longitudinal acceleration rate that is an acceleration rate in a vehicle front-rear direction, and a lateral acceleration rate that is an acceleration rate in a vehicle width direction. The acceleration sensor may further detect a vertical acceleration rate that is an acceleration rate in a vehicle height direction. The angular velocity sensor detects the rate of a change in rotation angle (roll angle) about an axis extending in the vehicle front-rear direction, the rate of a change in rotation angle (pitch angle) about an axis extending in the vehicle width direction, and the rate of a change in rotation angle (yaw angle) about an axis in the vehicle height direction. The angular velocity sensor may be a yaw rate sensor that detects the rate of a change in yaw angle.

Further, the vehicle behavior measurement device Il detects data that varies according to driving operations such as a steering operation, an accelerator operation, and a brake operation performed by the driver as the behavior data of the relevant vehicle 1, and outputs the detected behavior data to the information processing apparatus 100.

The vehicle behavior measurement device 11 may further include a sensor configured to measure data on which the behavior of the vehicle 1 is reflected, in addition to the vehicle speed sensor, the acceleration sensor, and the angular velocity sensor.

### (Vehicle Surrounding Condition Detector)

The vehicle surrounding condition detector 13 is a device that detects information on a surrounding condition of the vehicle 1. For example, the vehicle surrounding condition detector 13 includes one or more of a stereo camera, a monocular camera, a LiDAR (light detection and ranging/laser imaging detection and ranging), and a radar sensor. Note that, in the example of the vehicle 1 illustrated in FIG. 1, a pair of left and right front shooting cameras 13LF and 13RF, and a LIDAR 13S are provided as the vehicle surrounding condition detector 13.

Specifically, the vehicle surrounding condition detector 13 detects objects, such as other vehicles, bicycles, pedestrians, road signs, and other obstacles, present around the vehicle 1 based on the acquired data, and calculates distances, relative speeds, and relative positions to these objects. Further, the vehicle surrounding condition detector 13 detects information on the surrounding condition of the vehicle 1 such as a road width (hereinafter, referred to as “surrounding condition information”) based on the acquired data. Further, the vehicle surrounding condition detector 13 outputs the detected surrounding condition information to the information processing apparatus 100.

The vehicle surrounding condition detector 13 may further include a device configured to detect the surrounding condition information of the vehicle 1, in addition to the stereo camera, the monocular camera, the LiDAR, and the radar sensor.

### (Weather Information Detector)

The weather information detector 15 is a device that detects information on the weather in a traveling area of the vehicle 1. For example, the weather information detector 15 includes one or more of a stereo camera, a monocular camera, a rain sensor, an anemometer, and an acceleration sensor.

The weather information detector 15 detects rainfall, snowfall, snow accumulation, and road surface freezing based on image data obtained by the stereo camera or the monocular camera. Further, the weather information detector 15 estimates the amount of rainfall based on detection data of the rain sensor. Further, the weather information detector 15 detects a wind speed and a wind direction based on detection data of the anemometer. Furthermore, the weather information detector 15 estimates a wind speed and a wind direction based on sensor signals from the acceleration sensor. Thereafter, the weather information detector 15 outputs the detected information on the weather (hereinafter, referred to as “weather condition information”) to the information processing apparatus 100.

The weather information detector 15 may further include a device configured to detect the information on the weather in the traveling area of the vehicle 1, in addition to the stereo camera, the monocular camera, the rain sensor, the anemometer, and the acceleration sensor. Further, the weather information detector 15 may receive information from an external system, which may be telematics or the like, to acquire information on the weather in the traveling area (hereinafter, referred to as “weather reception information”). In this case, the weather information detector 15 outputs the detected weather reception information to the information processing apparatus 100.

### (Vehicle Position Information Detector)

The vehicle position information detector 17 receives positioning signals transmitted from a global navigation satellite system (GNSS) represented by the global positioning system (GPS) to measure a position of the vehicle 1. Thereafter, the vehicle position information detector 17 outputs the information on the measured position of the vehicle 1 (including information on latitude, longitude, and time) as position information to the information processing apparatus 100.

The vehicle position information detector 17 of the present embodiment may function as a part of the navigation system (not illustrated) that performs the driver assistance and guides the vehicle 1 to a destination. In this case, the vehicle position information detector 17 refers to map data of the navigation system (not illustrated) based on the measured position of the vehicle 1, identifies a current position of the vehicle, and outputs the identified position as the position information to the information processing apparatus 100.

The vehicle position information detector 17 may measure the position of the vehicle 1 by receiving positioning signals transmitted from another system such as a quasi-zenith satellite system in place of the GNSS or in combination with the GNSS.

### (Sound Output Device)

The sound output device 19 is a device that outputs a sound recognizable by the driver. The output of the sound output device 19 is controlled by the information processing apparatus 100. In particular, the sound output device 19 includes a reproduction unit that reproduces sound effect data stored in the information processing apparatus 100 or sound effect data provided from the management server 20. In addition to the reproduction unit, the sound output device 19 includes a D/A converter that converts a digital signal of a reproduced sound effect into an analog signal, an amplifier that amplifies the analog signal, and a structure such as a speaker that outputs a sound for stimulating the auditory sense of the driver into the vehicle 1.

In the vehicle 1 illustrated in FIG. 2, the sound output device 19 includes four speakers 31LF, 31RF, 31LR, and 31RR provided on left-front, right-front, left-rear, and right-rear sides of the vehicle 1, respectively. The sound output device 19 may include a speaker provided in the vehicle 1, or may be a speaker dedicated to the information processing system 10.

### (Information Processing Apparatus)

The information processing apparatus 100 includes one or more processors such as CPUs. The information processing apparatus 100 executes a computer program in conjunction with the management server 20 to collect and provide the behavior data for executing the driver assistance based on the auditory stimulation on the driver and to control the sound effect output.

In particular, the information processing apparatus 100 is configured to acquire various kinds of data or information outputted from the vehicle behavior measurement device 11, the vehicle surrounding condition detector 13, the weather information detector 15, and the vehicle position information detector 17.

As illustrated in FIG. 3, the information processing apparatus 100 includes a processor 110, an operation input unit 120, a memory 140, an information storage medium 150, and a communicator 170. Note that some of these components may be omitted. Part or the entire of the information processing apparatus 100 may be configured by updatable software such as firmware, or may be a program module or the like to be executed in response to a command from the CPU or the like.

The processor 110 reads and executes an application program (hereinafter, also referred to as an “application”) stored in the information storage medium 150 to perform various processes of the present embodiment. Any application may be stored in the information storage medium 150. The processor 110 of the present embodiment may read a program or data stored in the information storage medium 150, temporarily store the read program or data in the memory 140, and perform processing based on the program or data.

In particular, the processor 110 performs various processes using a main memory unit in the memory 140 as a work area. The processor 110 has a function to be implemented by hardware such as various processors (e.g., CPU or DSP) or an application program. Specifically, the processor 110 includes a communication control unit 111, an input reception processing unit 112, a data processing unit 113, an output control unit 114, and a timer management unit 119. Note that some of these components may be omitted.

The communication control unit 111 performs a process for transmitting and receiving data to/from the management server 20. In particular, the communication control unit 111 receives data transmitted from the management server 20 to execute control processing such as a process for storing the received data in the memory 140 and a process for transmitting various kinds of data to the management server 20.

The input reception processing unit 112 recognizes the input information inputted by a user using the operation input unit 120, and outputs the recognized information to the data processing unit 113.

The data processing unit 113 provides the management server 20 with the input information recognized by the input reception processing unit 112.

Further, the data processing unit 113 acquires the behavior data, the surrounding condition information, the weather detection information or the weather reception information (hereinafter collectively referred to as “weather information”), or the position information outputted from the vehicle behavior measurement device 11, the vehicle surrounding condition detector 13, the weather information detector 15, and the vehicle position information detector 17. The data processing unit 113 provides the acquired behavior data and each piece of the acquired information to the output control unit 114 or the management server 20.

The output control unit 114 acquires control data for outputting a sound effect provided from the management server 20 (hereinafter referred to as “sound effect output control data”), or acquires the sound effect output control data and the sound effect data. Further, the output control unit 114 controls the sound output device 19 based on the sound effect output control data provided from the management server 20 or based on the sound effect output control data and the sound effect data provided from the management server 20.

The timer management unit 119 has a function of measuring time from a current date and time or a predetermined timing, and outputs the current time and a result of the measurement when a predetermined timing arrives.

The operation input unit 120 is a device used by the driver to input given information, and is configured to output the information inputted by the driver (hereinafter, referred to as “input information”) to the processor 110.

For example, the operation input unit 120 includes a detection unit (not illustrated) that detects input information (input signal) inputted by the driver. The operation input unit 120 includes a lever, a button, a dial-type operation device, a microphone, a touch panel display, a keyboard, a mouse, or a camera that receives an input in the form of a gesture, or the like. In particular, when the operation input unit 120 includes a microphone, the detection unit 122 serves as a speech recognition device that receives an input in the form of a voice of an occupant including the driver. In addition, when the operation input unit 120 is includes a camera, the detection unit serves as an image recognition device that receives an input in the form of an image of a gesture captured by the camera.

The operation input unit 120 receives, as the input information, information on an attribute of the driver. The information on the attribute of the driver is information relevant to a driving skill of the driver. For example, the information on the attribute of the driver includes one or more of the following information: the age of the driver, the number of years after the acquisition of the driver's license, the frequency of driving, the number of years after the last driving, and the like.

The information on the attribute of the driver may include other pieces of information for estimating the driving skill of the driver. These pieces of the information may be inputted in the form of questionnaires presented from the information processing apparatus 100, and the driver or the like may answer to questions presented from the information processing apparatus 100. Alternatively, as these pieces of the information, preliminarily determined or accumulated pieces of data may be inputted.

The operation input unit 120 may receive, as the input information, information on a desired sound to be outputted as a sound effect. For example, the operation input unit 120 may be configured to operate in conjunction with the processor 110 to allow the driver or the like to select a desired sound (a musical instrument sound or a sound effect of various kinds) from the tone colors or the types of tones preliminarily stored in the memory 140 or the like. The sound data to be selected includes the sound effect data preliminarily stored in the memory 140 and the sound effect data provided from the management server 20.

The memory 140 serves as a work area of the processor 110, for example, and the function of the memory 140 is implemented by hardware such as a RAM (VRAM). The memory 140 of the present embodiment includes a main memory unit 141 that is used as a work area, and a data memory unit 142 that stores computer programs, table data, reference data, sound data, or the like to be used for executing each process.

Note that some of these components may be omitted. The computer program is a program that causes the processor to execute various operations to be executed by the information processing apparatus 100. Further, the computer program may be recorded in a recording medium built in the information processing apparatus 100 or any external recording medium attachable to the information processing apparatus 100.

The information storage medium 150 is readable by a computer. The information storage medium 150 may store various applications, operating systems (OS), and various types of data including ID corresponding to each information processing system 10.

That is, the information storage medium 150 stores an application that causes a computer to serve as each of the units of the present embodiment (an application that causes a computer to execute a process for each of the units), an ID for communicating with each information processing system 10, and the like.

For example, the information storage medium 150 may be a magnetic medium such as a hard disk, a floppy disk, or a magnetic tape, an optical recording medium such as a compact disk read only memory (CD-ROM), a digital versatile disk (DVD), or a Blu-ray (registered trademark), a magneto-optical medium such as a floptical disk, a storage device such as a RAM or a ROM, a flash memory such as a universal serial bus (USB) or a solid state drive (SSD), or another medium capable of storing programs.

The communicator 170 performs various kinds of control for communicating with an external device (e.g., the management server 20). The functions of the communicator 170 are configured by hardware such as various processors or a communication ASIC, a computer program, or the like.

### [B1.4] Management Server

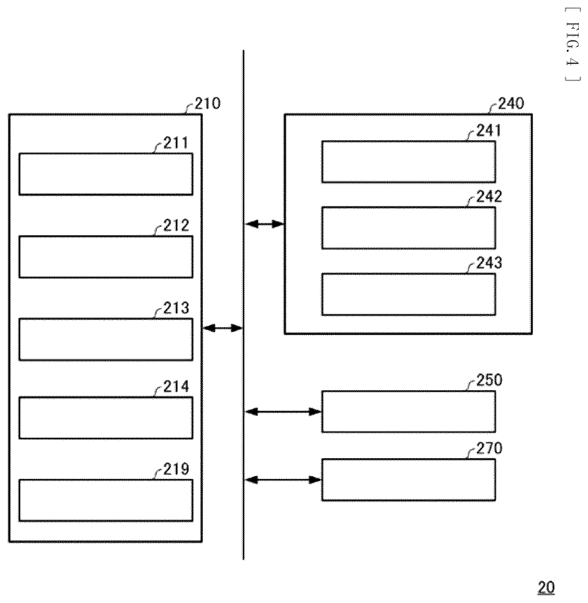

Next, a configuration example of the management server 20 of the present embodiment is described with reference to FIG. 4. FIG. 4 is a block diagram illustrating a configuration example of the management server 20 according to the present embodiment.

The management server 20 includes one or more processors such as CPUs, and performs the sound effect optimization output condition identification process by executing a computer program in conjunction with each information processing system 10.

In particular, the management server 20 of the present embodiment acquires the behavior data of the vehicle 1 based on the auditory stimulation on each driver, analyzes the behavior data, and identifies the sound effect output condition highly effective in stabilizing the behavior of each driver as the optimization output condition. Thereafter, the management server 20 provides the optimization sound effect output control data, which is data for controlling the output of a sound effect from the information processing system 10 in accordance with the identified optimization output condition, to the relevant information processing system 10 of the vehicle 1.

Part or the entire of the management server 20 may be configured by updatable software such as firmware, or may be a program module or the like to be executed in response to a command from the CPU or the like. The computer program is a program that causes the processor to execute various operations to be executed by the management server 20. The computer program to be executed by the processor may be recorded in a recording medium serving as a memory (storage unit) 240 provided in the management server 20, or may be recorded in a recording medium built in the management server 20 or any external recording medium attachable to the management server 20.

For example, the recording medium that records the computer program may be a magnetic medium such as a hard disk, a floppy disk, or a magnetic tape, an optical recording medium such as a compact disk read only memory (CD-ROM), a digital versatile disk (DVD), or a Blu-ray (registered trademark), a magneto-optical medium such as a floptical disk, a storage device such as a RAM and a ROM, a flash memory such as a universal serial bus (USB) or a solid state drive (SSD), or another medium capable of storing programs.

As illustrated in FIG. 4, the management server 20 includes a processor 210, the memory 240, an information storage medium 250, and a communicator 270. The processor 210 includes a communication control unit 211, a data acquisition unit 212, a data analysis unit 213, a data provision processing unit 214, and a timer management unit 219. Note that some of these components may be omitted.

The communication control unit 211 performs a process for transmitting and receiving data to/from each information processing system 10. In particular, the communication control unit 211 receives data transmitted from each information processing system 10, and executes control processing such as a process for storing the received data in the memory 240 and a process for transmitting various kinds of data to the information processing system 10 of each vehicle 1.

The data acquisition unit 212 acquires the behavior data from the information processing system 10 of each vehicle 1, and outputs the behavior data to the data analysis unit 213.

The data analysis unit 213 sets the sound effect output control data to be provided to the information processing system 10. The sound effect output control data is data for analyzing the behavior of the driver of the vehicle 1 and includes a predetermined output condition for outputting a sound effect into the vehicle 1 (hereinafter, referred to as “sound effect output control data for behavior analysis”).

When the sound effect output control data for behavior analysis is set, the data acquisition unit 212 may identify the type of the sound effect to be outputted into the vehicle 1.

The data provision processing unit 214 provides the sound effect output control data for behavior analysis set by the data analysis unit 213 to the information processing system 10 of each vehicle 1 via the communicator 270 under the control of the communication control unit 211.

The timer management unit 219 has a function of measuring time from a current date and time or a predetermined timing, and outputs the current time and a result of the measurement when a predetermined timing arrives or when a predetermined request is received.

The memory 240 serves as a work area of the processor 210, for example, and the function of the memory 240 is implemented by hardware such as a RAM (VRAM). The memory 240 of the present embodiment includes a main memory unit 241 that is used as a work area, a data memory unit 242 that stores computer programs, table data, and reference data that are used to execute each process, and a driver data memory unit 243 that stores data on the driver.

Note that some of these components may be omitted. The computer program is a program that causes the processor to execute various operations to be executed by the management server 20. The computer program to be executed by the processor may be recorded in a recording medium built in the management server 20 or any external recording medium attachable to the management server 20.

The information storage medium 250 is readable by a computer. The information storage medium 250 may store various applications, operating systems (OS), and various types of data including ID corresponding to each information processing system 10.

That is, the information storage medium 250 stores an application that causes a computer to serve as each of the units of the present embodiment (an application that causes a computer to execute a process for each of the units), an ID for communicating with each information processing system 10, and the like.

For example, the information storage medium 250 may be a magnetic medium such as a hard disk, a floppy disk, or a magnetic tape, an optical recording medium such as a compact disk read only memory (CD-ROM), a digital versatile disk (DVD), or a Blu-ray (registered trademark), a magneto-optical medium such as a floptical disk, a storage device such as a RAM or a ROM, a flash memory such as a universal serial bus (USB) or a solid state drive (SSD), or another medium capable of storing programs.

The communicator 270 performs various kinds of control for communicating with an external device (e.g., each information processing system 10). The functions of the communicator 270 are configured by hardware such as various processors or a communication ASIC, a computer program, or the like.

### [B1.5] Sound Effect Optimization Output Condition Identification Process of Present Embodiment

### [B1.5.1] Outline

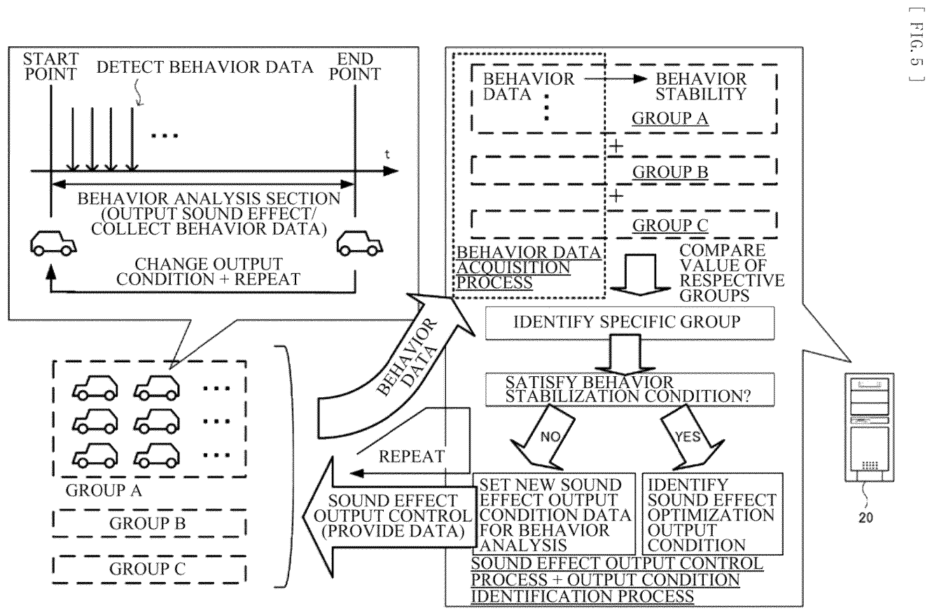

Next, the sound effect optimization output condition identification process for identifying the sound effect optimization output condition in the driver assistance based on the auditory stimulation according to the present embodiment is described with reference to FIG. 5. FIG. 5 is a diagram for describing the sound effect optimization output condition identification process according to the present embodiment.

The management server 20 of the present embodiment is configured to execute the following processing as the sound effect optimization output condition identification process. The management server 20 executes a behavior data acquisition process for acquiring the behavior data of each vehicle 1 from the vehicle 1 while the vehicle 1 is traveling in at least a predetermined section. After the vehicle 1 passes through the predetermined section, the management server 20 executes a sound effect output control process for executing control that causes the vehicle 1 to output a sound effect corresponding to behavior stability retrieved from the behavior data of the vehicle 1 acquired in the predetermined section. The management server 20 repeatedly executes the behavior data acquisition process and the sound effect output control process while changing the output condition of the sound effect. When the result obtained through these processes satisfies a setting condition set in advance, the management server 20 executes an identification process for identifying the output condition corresponding to the result as an optimization output condition.

In particular, the management server 20 of the present embodiment selects a plurality of groups each including one or more drivers grouped in advance as a premise of the behavior data acquisition process and the sound effect output control process. Thereafter, the management server 20 sets the sound effect output control data for behavior analysis having different conditions for outputting the sound effect into the vehicle 1 for the respective selected groups (hereinafter, referred to as “behavior analysis reference data”), and provides the behavior analysis reference data to the information processing system 10 of each vehicle 1.

Further, the management server 20 of the present embodiment uses, as the sound effect output condition of the present embodiment, one or more of the output timing, the number of outputs, the tone color, the volume, the length, and the tempo of the sound effect, as described above. Thereafter, the management server 20 executes the behavior data acquisition process and the sound effect output control process while changing these output conditions or a combination thereof, and executes, as a result of the processes, a process for identifying a provisional optimal sound effect output condition (hereinafter, referred to as the “output condition identification process”). Finally, when the provisional optimal output condition obtained as a result of the processes satisfies a setting condition set in advance (hereinafter, referred to as a “behavior stabilization condition”), the management server 20 identifies the provisional optimal output condition as the optimization output condition.

Specifically, as illustrated in FIG. 5, after the vehicle 1 passes through the predetermined section, the management server 20 executes the behavior data acquisition process for acquiring each piece of behavior data collected based on the sound effect output control data for behavior analysis including the behavior analysis reference data. As illustrated in FIG. 5, when acquiring the respective pieces of the behavior data, the management server 20 sets new sound effect output control data for behavior analysis having different output conditions for the respective groups based on the acquired pieces of the behavior data of the respective groups. Thereafter, as illustrated in FIG. 5, the management server 20 provides the set sound effect output control data for behavior analysis to the information processing system 10 of each vehicle 1 as the sound effect output control process, and executes the behavior data acquisition processing of acquiring the respective pieces of the behavior data, and repeatedly executes these processes.

Further, as illustrated in FIG. 5, as the output condition identification process, the management server 20 compares the behavior stability of each group retrieved from the behavior data to identify the provisional optimal sound effect output condition, and identifies the group to which the optimal output condition is set as a specific group. As illustrated in FIG. 5, the management server 20 executes a determination process for determining whether the processing result (e.g., the sound effect output condition of the specific group) obtained by repeatedly executing the behavior data acquisition process and the sound effect output control process satisfies the predetermined behavior stabilization condition. In this case, when the execution result is determined to satisfy the behavior stabilization condition in the determination process, the management server 20 identifies the output condition identified as the provisional optimal output condition (e.g., the sound effect output condition of the specific group) as the sound effect optimization output condition.

As described above, the management server 20 of the present embodiment is configured to execute the output condition identification process while repeatedly executing the sound effect output control process and the behavior data acquisition process based thereon with changing the sound effect output condition for each group, and eventually identify the sound effect optimization output condition.

As illustrated in FIG. 5, after the vehicle passes through the predetermined section for the behavior analysis (hereinafter, referred to as a “behavior analysis section”), each information processing system 10 collects the behavior data indicating the behavior of the vehicle based on the sound effect reproduced while the vehicle is traveling in the behavior analysis section, and provides the collected behavior data to the management server 20.

In addition, when the sound effect optimization output condition is identified as described above, the management server 20 provides the information processing system 10 with control data including the identified optimization output condition (hereinafter, referred to as “optimization sound effect output control data”). Thereafter, the information processing system 10 reproduces the sound effect data based on the optimization sound effect output control data to output a predetermined sound effect into the vehicle 1 in a section desired by the driver or a section in which a stable behavior is essential (hereinafter, also referred to as an “application section”).

With such a configuration, the management server 20 or the driver assistance network system S including the management server 20 of the present embodiment makes it possible to automatically identify the sound effect optimization output condition for performing the auditory stimulation on the driver to assist, as long as the actual vehicle behavior data based on the driving operation of the driver is able to be collected.

In addition, the management server 20 or the driver assistance network system S including the management server 20 of the present embodiment makes it possible to collect the data regarding the actual vehicle behavior in response to the auditory stimulation on the driver, and thus makes it possible to accurately identify the sound effect output condition that increases the behavior stability of the driver to assist.

That is, the management server 20 or the driver assistance network system S including the management server 20 of the present embodiment makes it possible to automatically identify the output condition optimal for the driver, such as the optimal output timing, the optimal sound type, or the optimal tone color of the sound effect to enhance the behavior stability.

Further, the management server 20 or the driver assistance network system S including the management server 20 of the present embodiment makes it possible to accurately stimulate the auditory sense of the driver so as to enhance the behavior stability by simply providing the driver with the sound effect output condition automatically identified.

### [B1.5.2] Driver Data and Group Data

Next, driver data and group data that are used in the sound effect optimization output condition identification process of the present embodiment are described with reference to FIGS. 6 and 7. FIG. 6 illustrates an example of the driver data stored in the driver data memory unit 243 of the present embodiment, and FIG. 7 illustrates an example of the group data stored in the driver data memory unit 243 of the present embodiment.

The driver data memory unit 243 stores data relating to each driver (hereinafter, referred to as “driver data”) and data relating to each group (hereinafter, referred to as “group data”).

As illustrated in FIG. 6, the driver data includes attribute information, vehicle ID for identifying each vehicle 1 driven by each driver, system ID for identifying the information processing system 10 mounted in the vehicle 1, and the like, that are associated with driver ID for identifying each driver.

The group data is data relating to the groups selected in advance in order to analyze the behavior of the vehicle 1 of each driver, and is data for identifying drivers belonging to the respective groups for each group. Specifically, as illustrated in FIG. 7, the group data includes the ID of drivers belonging to the respective groups for each group.

The group data of the present embodiment may include the vehicle ID of the vehicle 1, the system ID of the information processing system 10, or a combination thereof, instead of the driver ID or together with the driver ID. The groups may be determined in advance at random or by any method. However, it is preferable to group the drivers who drive the vehicles 1 that satisfy essential conditions regarding traveling of the vehicles 1, such as the vehicles 1 having traveled in the same traveling section, the vehicles 1 having traveled in the same traveling distance, or the vehicles 1 having traveled in the same traveling time in the same group.

### [B1.5.3] Processing Relating to Sound Effect Optimization Output Condition Identification Process by Information Processing System

Next, a description is given of each process executed by the information processing system 10 in relation to the sound effect optimization output condition identification process of the present embodiment.

### (Sound Effect Output Control Based on Sound Effect Output Control Data for Behavior Analysis)

In order to provide the management server 20 with the behavior data of each vehicle 1, the output control unit 114 executes, in the behavior analysis section, the sound effect output control for each piece of the sound effect output control data for behavior analysis (including the behavior analysis reference data to be described later) having the different sound effect output conditions.

Specifically, under the control of the communication control unit 111, the output control unit 114 acquires the sound effect output control data for behavior analysis having the different sound effect output conditions via the communicator 170, and stores the acquired sound effect output control data for behavior analysis in the memory 140. Further, when a start point or a start timing of the behavior analysis section is detected, the output control unit 114 reproduces predetermined sound effect data based on the stored sound effect output control data for behavior analysis, and causes the sound output device 19 to output the sound effect. Thereafter, when an end point or an end timing of the behavior analysis section is detected, the output control unit 114 stops reproducing the sound effect data based on the sound effect output control data for behavior analysis.

For example, the output control unit 114 detects passing of the vehicle through the start point and the end point of the behavior analysis section based on the position information acquired from the vehicle position information detector 17. The output control unit 114 may detect the behavior analysis section based on, for example, the current time outputted from the timer management unit 119, the surrounding condition information outputted from the vehicle surrounding condition detector 13, or the weather information outputted from the weather information detector 15. Alternatively, the output control unit 114 may detect the behavior analysis section based on, for example, a combination of two or more of the position information, the current time, the surrounding condition information, and the weather information.

### (Collection of Behavior Data and Transmission to Management Server)

When the sound effect is reproduced based on the sound effect output control data for behavior analysis, the data processing unit 113 collects the behavior data outputted from the vehicle behavior measurement device 11 at each predetermined timing. Further, under the control of the communication control unit 111, the data processing unit 113 transmits the collected behavior data as a group of the behavior data to the management server 20 via the communicator 170.

In particular, the data processing unit 113 collects the behavior data at each predetermined timing while the vehicle 1 is traveling in the behavior analysis section. The behavior analysis section is a section partitioned by a predetermined traveling distance, a section partitioned by a predetermined traveling time, or a section partitioned at each reference point such as an intersection provided with a traffic light, for example. Further, the data processing unit 113 collects, as the behavior data, values of an acceleration rate, an angular velocity, a jerk, or an angular acceleration rate, or two or more thereof at predetermined timings.

The data processing unit 113 may transmit a data group in which the collected pieces of the behavior data are arranged in a time series manner to the management server 20, or may sequentially transmit the collected behavior data to the management server 20. In this case, it is preferable that the data processing unit 113 transmit the behavior data group to the management server 20 for each type of the sound effect output control data for behavior analysis (hereinafter, referred to as “data type”) by attaching the driver ID stored in the memory 140 or by attaching the data type ID.

In the present embodiment, one or more pieces of the behavior data may be collected and transmitted to the management server 20 for each vehicle 1 and for each behavior analysis section. However, in order to reflect an appropriate behavior of each vehicle 1, it is preferable that the data processing unit 113 collect a plurality of pieces of the behavior data and transmits the collected pieces of the behavior data to the management server 20.

### (Sound Effect Output Control Based on Optimization Sound Effect Output Control Data)

The output control unit 114 executes the sound effect output control based on the optimization sound effect output control data in the application section such as a section desired by the driver.

Specifically, under the control of the communication control unit 111, the output control unit 114 acquires the optimization sound effect output control data via the communicator 170, and stores the acquired optimization sound effect output control data in the memory 140. Further, when a start point or a start timing of the application section is detected, the output control unit 114 reproduces predetermined sound effect data based on the stored optimization sound effect output control data, and causes the sound output device 19 to output the sound effect. When an end point or an end timing of the application section is detected, the output control unit 114 stops reproducing the sound effect data based on the optimization sound effect output control data.

### [B.1.5.4] Processes in Sound Effect Optimization Output Condition Identification Process by Management Server

### [B1.5.4.1] Process for Setting Behavior Analysis Reference Data

Next, a description is given of a process for setting the behavior analysis reference data to be executed by the data analysis unit 213 before the data acquisition process and the sound effect output control process for the present embodiment are executed.

The data analysis unit 213 sets, as the behavior analysis reference data, the sound effect output control data having the predetermined output conditions different for each selected group.

In particular, the data analysis unit 213 divides a plurality of drivers traveling in the predetermined section into a plurality of groups at random or in accordance with a predetermined algorithm or the like, and stores the driver ID of the drivers belonging to the respective groups in the driver data memory unit 243 for each group. Further, the data acquisition unit 212 sets, for each group, the behavior analysis reference data defining the sound effect output condition, such as the output timing of the sound effect, in accordance with an algorithm capable of identifying the optimization output condition based on the behavior data.

For example, when a binary search is used to identify the optimization output condition, the data analysis unit 213 uses the behavior analysis reference data that defines the earliest timing, the latest timing, and an intermediate timing (median value) after the start of the behavior analysis. Further, in this case, when three groups are provided, the data analysis unit 213 sets, for the respective groups, the sound effect output control data for behavior analysis having different output timings, such as 1 second, 3 seconds, or 5 seconds later than the start of the behavior analysis or the start of driving.

In the present embodiment, the three groups are provided to obtain the behavior data in accordance with the predetermined sound effect output condition, as described above. However, two or more groups may be selected and applied to the process relating to the driver assistance based on the auditory stimulation according to the present embodiment. However, in order to analyze an accurate behavior tendency of the vehicle 1, it is preferable to provide three or more groups.

Further, although the optimization output condition is identified using the binary search in the present embodiment, another search algorithm such as a linear search using a predetermined output condition may be used.

### [B1.5.4.2] Behavior Data Acquisition Process

Next, a description is given of the behavior data acquisition process to be executed by the data acquisition unit 212 according to the present embodiment based on the behavior analysis reference data or the sound effect output control data for behavior analysis.

### (Behavior Data Acquisition Process Based on Behavior Analysis Reference Data)

Under the control of the communication control unit 211, the data acquisition unit 212 acquires the behavior data collected by the information processing system 10 of each vehicle 1 based on the behavior analysis reference data via the communicator 270, and outputs the acquired behavior data to the data analysis unit 213.

Specifically, the data acquisition unit 212 acquires, from each of the information processing systems 10, the data collected for each vehicle 1 by the information processing system 10 mounted in the vehicle 1 while the vehicle 1 is traveling in the behavior analysis section, i.e., the behavior data indicating the behavior of each vehicle 1 in the behavior analysis section. That is, when the sound effect output control is performed in the behavior analysis section based on the behavior analysis reference data assigned to each driver, the data acquisition unit 212 acquires one or more pieces of the behavior data collected from each vehicle 1 for each group.

It is sufficient for the data acquisition unit 212 of the present embodiment to acquire one or more pieces of the behavior data for each vehicle 1 and for each behavior analysis section. However, in order to reflect an appropriate behavior of each vehicle 1, it is preferable to acquire a plurality of pieces of the behavior data. Note that, in the following description, the term “behavior data” refers to “one or more pieces of behavior data” unless otherwise stated.

### (Behavior Data Acquisition Process Based on Sound Effect Output Control Data for Behavior Analysis)

Under the control of the communication control unit 211, the data acquisition unit 212 acquires the behavior data collected by the information processing system 10 of each vehicle 1 based on the sound effect output control data for behavior analysis via the communicator 270, in a similar manner to that for the behavior analysis reference data. Thereafter, the data acquisition unit 212 outputs the acquired behavior data to the data analysis unit 213.

### [B1.5.4.3] Sound Effect Output Control Process Including Process for Setting Sound Effect Output Control Data for Behavior Analysis

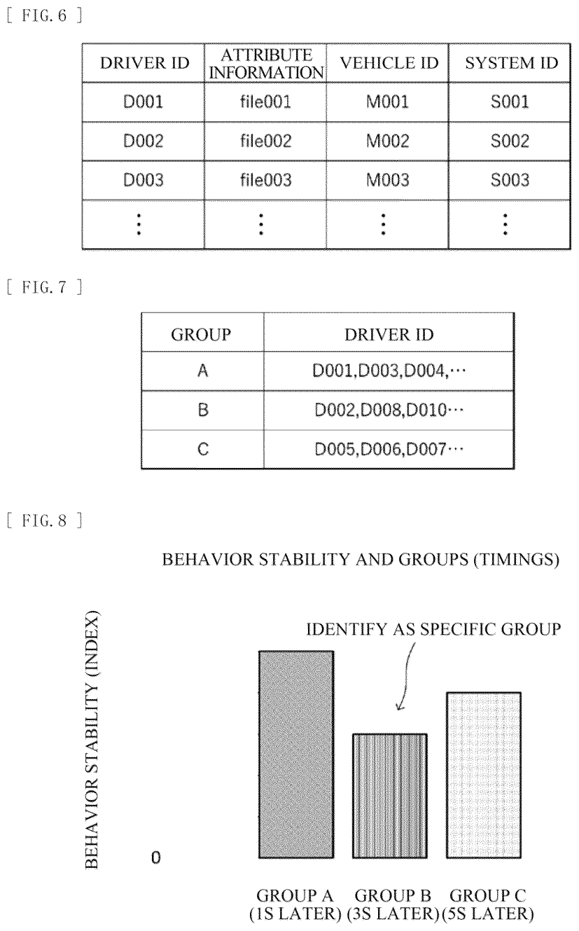

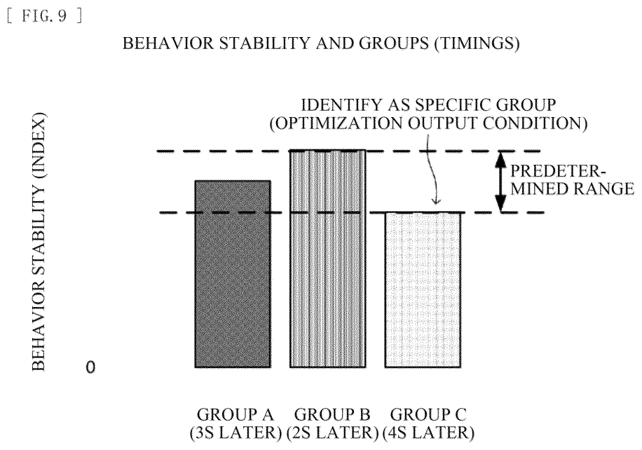

Next, the sound effect output control process including the process for setting the sound effect output control data for behavior analysis to be executed by the data analysis unit 213 of the present embodiment is described with reference to FIG. 8. FIG. 8 is a diagram for describing the sound effect output control process including the process for setting the sound effect output control data for behavior analysis to be executed by the data analysis unit 213 of the present embodiment.

### (Process for Setting Sound Effect Output Control Data for Behavior Analysis)

As described above, when the behavior data based on the behavior analysis reference data is acquired from each vehicle 1, the data analysis unit 213 calculates an index value indicating the behavior stability of each vehicle 1 (hereinafter, referred to as a “behavior stability index value”) based on the behavior data of each vehicle 1. Thereafter, the data analysis unit 213 calculates the behavior stability index value of each vehicle 1 for each group, and identifies a group having an index value indicating optimal behavior stability as a specific group from among the groups. Further, the data analysis unit 213 determines the sound effect output condition set to the specific group as a provisional sound effect optimization output condition, and sets new sound effect output control data for behavior analysis based on the provisional sound effect optimization output condition determined.

Specifically, the data analysis unit 213 calculates the behavior stability index value of each vehicle 1 based on the values (data values) of the vehicle speed, the acceleration rate (the longitudinal acceleration rate, the lateral acceleration rate, or the vertical acceleration rate) or the angular velocity (the angular velocity of the yaw angle, the roll angle, and the pitch angle) indicated by the behavior data.

In particular, the data analysis unit 213 executes one or more of a smoothing process, an absolute value conversion process, and a differentiation process on the vehicle speed, the acceleration rate, or the angular velocity to calculate a value indicating the magnitude of the behavior of the vehicle 1. For example, the data analysis unit 213 performs the smoothing process, the absolute value conversion process, and the differentiation process on the data values of the vehicle speed, the acceleration rate, or the angular velocity to calculate an absolute value of the acceleration rate, a jerk of the absolute value of the acceleration rate, or a jerk of an absolute value of the angular velocity (angular acceleration rate). However, the data analysis unit 213 may use the calculated absolute value of the acceleration rate, the calculated absolute value of the angular velocity, the calculated absolute value of the jerk, or the calculated absolute value of the angular acceleration rate as it is as the index value. When the absolute value of the jerk or the angular acceleration rate is used as the index value, an influence on a change in the vehicle speed, the acceleration rate, or the angular velocity due to an influence of the trajectory of the traveling path or acceleration and deceleration of another vehicle is reduced. This makes it possible to evaluate a change in the behavior of the vehicle 1 due to a driving operation state of the driver more accurately.

Further, the data analysis unit 213 may calculate one index value using a plurality of data values among the absolute value of the acceleration rate, the absolute value of the angular velocity, the absolute value of the jerk, and the absolute value of the angular acceleration rate. The data analysis unit 213 may replace the data value of each piece of behavior data to be used with the same index (e.g., a value of 0 to 100), and may use an average value of the values obtained by replacing all the data values to be used with the same index as the index value.

The data analysis unit 213 calculates the acceleration rate and the jerk individually for one or more of the longitudinal acceleration rate, the lateral acceleration rate, and the vertical acceleration rate. Further, the data analysis unit 213 calculates the angular velocity and the angular acceleration rate individually for one or more of the yaw angle, the roll angle, and the pitch angle. In particular, the index value calculated by the data analysis unit 213 takes a larger value as the behavior of the vehicle 1 becomes larger, and takes a smaller value as the behavior becomes smaller.

The data analysis unit 213 calculates a representative value from among the respective behavior stability index values calculated from the plurality of pieces of the behavior data for each driver. For example, the data analysis unit 213 may set a maximum value from among the plurality of index values as the representative value, or may set a statistical value such as an average value as the representative value. Further, after calculating the behavior stability index value of each driver, the data analysis unit 213 calculates the behavior stability index value of each group based on the behavior stability index value of each driver for each group. For example, the data analysis unit 213 calculates the average value of the index values of the drivers for each group as the behavior stability index value of each group.

After calculating the behavior stability index value of each group, the data analysis unit 213 determines a group having the index value satisfying a predetermined condition to be a specific group from among the behavior stability index values of the respective groups.

Further, the data analysis unit 213 identifies the sound effect output condition set to the specific group as the provisional optimization output condition, and sets new sound effect output control data for behavior analysis based on the identified provisional optimization output condition. That is, the data analysis unit 213 sets, for each group, the sound effect output control data for behavior analysis in which the provisional optimization output condition and the output condition determined based on the provisional optimization output condition are defined.

Specifically, the data analysis unit 213 determines an output condition of the sound effect output control data for behavior analysis to be newly set based on the provisional optimization output condition and the output condition at the time of setting the behavior analysis reference data. Further, the data analysis unit 213 determines the new output condition for the number of groups that is smaller by “1” than the number of groups for which the behavior analysis reference data are set. For example, when the behavior analysis reference data are set for three groups, the data analysis unit 213 determines the output condition of one of the three groups to be the provisional sound effect output condition, and determines the new output conditions for the two groups.

In particular, when a binary search is used as a search algorithm to set the output conditions having the different output timings, the data analysis unit 213 sets the earliest settable timing and the latest settable timing as the new output conditions, centering on the provisional output condition. In this case, the data analysis unit 213 sets two pieces of the sound effect output control data for behavior analysis having the new output conditions and one piece of the sound effect output control data for behavior analysis having the provisional output condition.

For example, as illustrated in FIG. 8, three pieces of the behavior analysis reference data defining the sound effect output timings as “1 second later”, “3 seconds later”, and “5 seconds later” than the start of the behavior analysis section may be respectively set to three groups A, B, and C, as described above. In this case, the group B defined as “3 seconds later” has the smallest behavior stability index value.

In this case, the data analysis unit 213 determines the group B defined as “3 seconds later” as the specific group, and determines the output condition set for the group B as the provisional optimization output condition. Further, the data analysis unit 213 sets the output conditions for the two groups (in specific, the groups A and C) using a binary search algorithm, based on the output condition of the group B defined as “3 seconds later”. That is, the data analysis unit 213 determines the output timings after the start of the behavior analysis section for the groups A and C to be the earliest settable output timing “2 seconds later” and the latest settable output timing “4 seconds later”, respectively. Thereafter, the data analysis unit 213 determines the sound effect output condition for the next timing for each group, and sets the sound effect output control data for behavior analysis to acquire the behavior data based on the determined output condition.

### (Sound Effect Output Control Process)

In the sound effect output control process, the data provision processing unit 214 provides each piece of the sound effect output control data for behavior analysis including the data on the new output condition to the relevant information processing system 10 via the communicator 270 under the control of the communication control unit 211, in a similar manner to that for the behavior analysis reference data.

That is, in the sound effect output control process, the data provision processing unit 214 provides each piece of the sound effect output control data for behavior analysis to the relevant information processing system 10, and causes the information processing system 10 to control the sound effect output based on the sound effect output control data for behavior analysis.

There is no change in the sound effect output control data for behavior analysis having the provisional optimization output condition, and the data provision processing unit 214 may thus control the sound effect output based on the sound effect output control data for behavior analysis having the provisional optimization output condition that has been already provided to the relevant information processing system 10.

### [B1.5.4.4] Output Condition Identification Process Including Resetting Sound Effect Output Control Data for Behavior Analysis

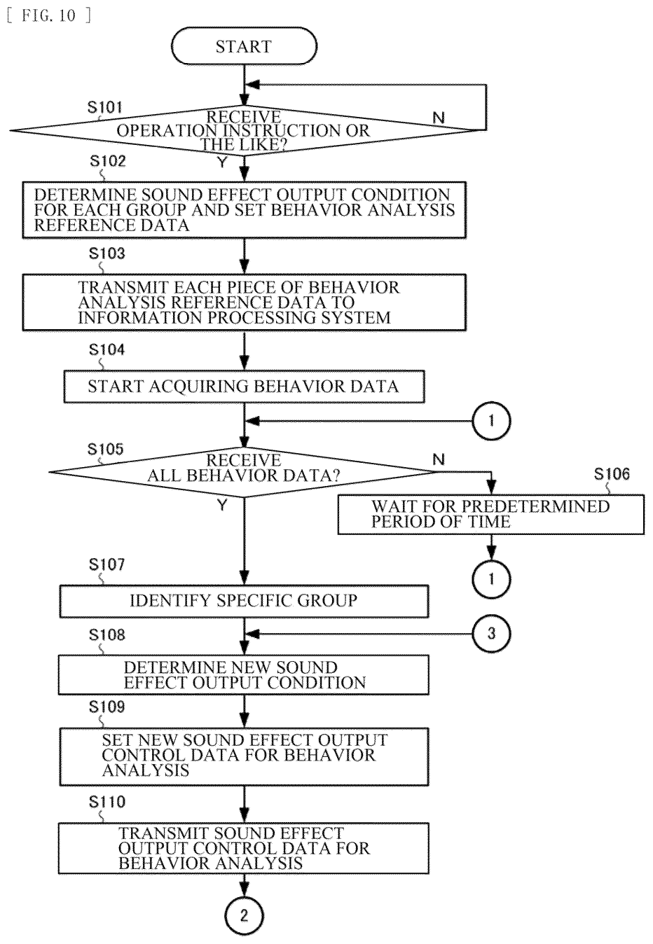

Next, the output condition identification process including resetting the sound effect output control data for behavior analysis to be executed by the data analysis unit 213 of the present embodiment is described with reference to FIG. 9. FIG. 9 is a diagram for describing the output condition identification process including resetting the sound effect output control data for behavior analysis to be executed by the data analysis unit 213 of the present embodiment.

The data analysis unit 213 acquires the behavior data from each vehicle 1, and calculates the behavior stability index value of each vehicle 1 in a similar manner to the case of setting the new sound effect output control data for behavior analysis based on the behavior data collected by the behavior analysis reference data. Thereafter, the data analysis unit 213 calculates the behavior stability index value of each group based on the behavior stability index value of each vehicle 1 calculated as described above, and identifies a specific group having the index value indicating the optimal behavior stability from among the plurality of groups based on the behavior stability index value of each group.

When the specific group is identified, the data analysis unit 213 executes a determination process for determining whether the index value indicating the behavior stability of the specific group or a result such as the number of times of the repetitive execution (hereinafter referred to as “repetitive execution result”) satisfies the predetermined behavior stabilization condition. At this time, when the repetitive execution result satisfies the predetermined behavior stabilization condition, the data analysis unit 213 executes the output condition identification process for identifying the sound effect output condition set for the specific group as the optimization output condition.

For example, as illustrated in FIG. 9, as the behavior stabilization condition, when it is determined that a difference between the index value of the smallest group and the index values of the other groups is within a predetermined range, the data analysis unit 213 identifies the output condition of the group whose index value is the smallest as the optimization output condition. In particular, in the present embodiment, when the difference between the index value of the smallest group and the index values of the other groups is less than 10% or within a range in which no significant difference is observed in the statistical test (so-called error range), for example, the data analysis unit 213 determines in the determination process that the difference is within the predetermined range.

In FIG. 9, the sound effect output timings set for the groups A, B, and C are 3 seconds later, 2 seconds later, and 4 seconds later, respectively, and the group C defined as “4 seconds later” corresponds to the specific group. In particular, in the example illustrated in FIG. 9, the sound effect output condition set for the group C is identified as the optimization output condition by determining that the behavior stability index value of the group C satisfies the predetermined behavior stabilization condition. That is, in the example of FIG. 9, the index value of the group C that is the specific group is a minimum index value, and the difference between the index value of the group C and the index values of the other groups A and B (corresponding to the output timings “3 seconds later” and “2 seconds later”, respectively) is within the predetermined range (e.g., less than 10%).

In contrast, when the repetitive execution result such as the index value indicating the behavior stability of the specific group does not satisfy the predetermined behavior stabilization condition, the data analysis unit 213 determines the sound effect output condition set for the specific group to be the provisional optimization output condition in a similar manner to that described above. Further, the data analysis unit 213 determines a new output condition of the sound effect output control data for behavior analysis to be newly set based on the provisional optimization output condition and the output condition at the time of setting the behavior analysis reference data in the same manner as described above.

In the above example, when the difference between the index value of the specific group (the output timing: “4 seconds later”) and the index value of the other groups (the output timings: “3 seconds later” and “2 seconds later”) is not within the predetermined range, the data analysis unit 213 sets the output condition of the specific group as the provisional optimization output condition. In this case, the data analysis unit 213 determines the output conditions for the two groups using a search algorithm such as a binary search algorithm based on the output condition of the specific group defining the output timing as “4 seconds later”. In this case, the data analysis unit 213 determines the output timings at which the sound effect is outputted to be 3.5 seconds later and 4.5 seconds later than the start of the behavior analysis section, as the output conditions other than the provisional optimization output condition.

When the sound effect output condition for the next timing of each group is determined in a similar manner to that described above, the data analysis unit 213 sets the sound effect output control data for behavior analysis to acquire the behavior data based on the determined output condition. In this case, the data provision processing unit 214 provides the newly set sound effect output control data for behavior analysis to the relevant vehicle 1 in the sound effect output control process.

### [B1.6] Operations of Present Embodiment

### [B1.6.1] Operation of Management Server

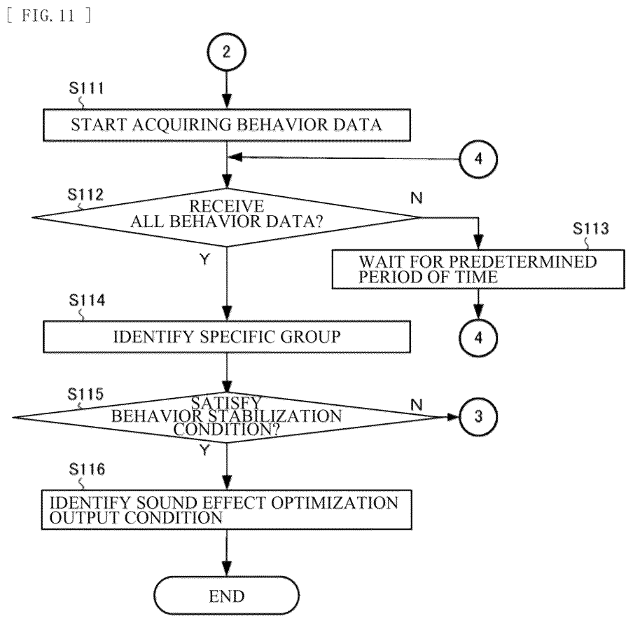

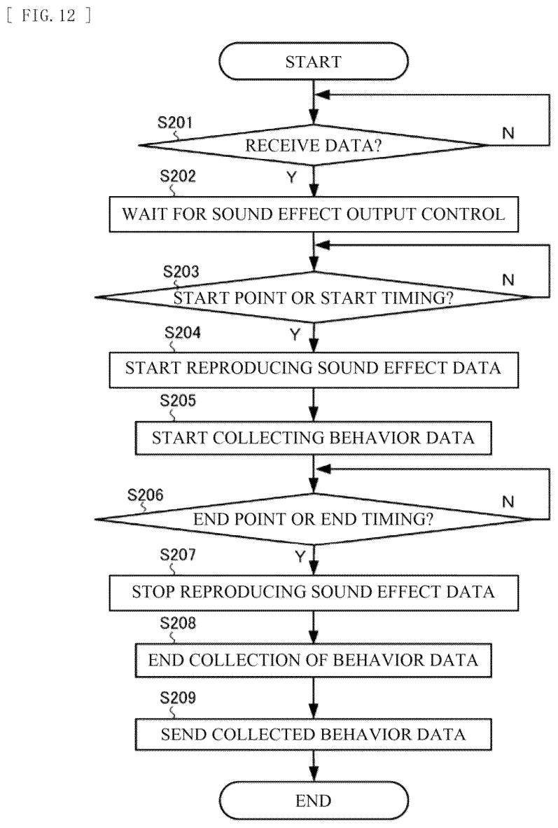

Next, an operation of the sound effect optimization output condition identification process to be executed by the management server 20 of the present embodiment is described with reference to FIGS. 10 and 11. FIGS. 10 and 11 are flowcharts of the operations of the sound effect optimization output condition identification process to be executed by the management server 20 of the present embodiment.

In this operation, it is assumed that a plurality of groups including one or more drivers grouped in advance are selected, and the driver ID belonging to the respective groups are already stored in the driver data memory unit 243.

Further, in the present operation, it is assumed that driving of the relevant vehicle 1 is started by a specific driver, and the information processing system 10 controls the output of a predetermined sound effect to perform auditory stimulation while the vehicle 1 is traveling in the predetermined section.

First, when receiving an instruction, such as an operation instruction from the specific driver or an instruction from an application, to execute the sound effect optimization output condition identification process (Step S101), the data analysis unit 213 sets the behavior analysis reference data for the respective predetermined groups (Step S102).

Thereafter, the data provision processing unit 214 transmits the behavior analysis reference data set for each group to the respective information processing systems 10 of the relevant vehicles 1 based on the group data stored in the driver data memory unit 243 (Step S103). The data provision processing unit 214 may set a group whose behavior analysis reference data is to be transmitted at random, or may set a group whose behavior analysis reference data is to be transmitted according to a rule determined in advance by an application or the like.

Thereafter, the data acquisition unit 212 starts acquiring the behavior data transmitted from the respective information processing systems 10 (Step S104). In particular, the data acquisition unit 212 may receive all the behavior data obtained in the predetermined section from the respective information processing systems 10 at a time, or may receive each piece of the collected behavior data.

Thereafter, the data acquisition unit 104 determines whether the behavior data have been received from all the information processing systems 10 belonging to the respective groups after passing through the predetermined section (Step S105). At this time, when it is determined that the behavior data have been received from all the drivers belonging to the respective groups after passing through the predetermined section, the data acquisition unit 204 causes the process to proceed to Step S107. When it is determined that the behavior data have not been received from all the drivers, the data acquisition unit 204 waits for a predetermined period of time (Step S106), and executes the process of Step S105 again.

Thereafter, based on the acquired behavior data, the data analysis unit 213 calculates the index value indicating the behavior stability of each vehicle 1 for each group, and identifies the group having index value indicating the optimal behavior stability as a specific group from among the plurality of groups (Step S107).

Thereafter, the data analysis unit 213 determines the sound effect output condition set for the specific group as the provisional sound effect optimization output condition, and determines the sound effect output condition for analyzing next behavior stability based on the determined provisional sound effect optimization output condition (Step S108).

Thereafter, the data analysis unit 213 sets new sound effect output control data for behavior analysis for the respective groups based on the output conditions determined in the process of Step S108 including the provisional sound effect optimization output condition (Step S109).

Thereafter, based on the group data stored in the driver data memory unit 243, the data provision processing unit 214 transmits the sound effect output control data for behavior analysis set for the respective groups to the respective information processing systems 10 of the relevant vehicles 1 (Step S110). As in Step S103, the data provision processing unit 214 may set a group whose sound effect output control data for behavior analysis is to be transmitted at random, or may set a group whose sound effect output control data for behavior analysis is to be transmitted according to a rule determined in advance by an application or the like.

Thereafter, the data acquisition unit 212 starts acquiring the behavior data transmitted from the respective information processing systems 10 as in Step S104 (Step S111).

Thereafter, as in the process of Step S105, the data acquisition unit 104 determines whether the behavior data have been received from all the drivers belonging to the respective groups after passing through the predetermined section (Step S112). At this time, when it is determined that the behavior data have been received from all the drivers belonging to the respective groups after passing through the predetermined section, the data acquisition unit 204 causes the process to proceed to Step S114. When it is determined that the behavior data have not been received from all the drivers, the data acquisition unit 204 waits for a predetermined period of time (Step S113), and executes the process of Step S112 again.

Thereafter, as in Step S107, the data analysis unit 213 identifies the specific group from among the plurality of groups while calculating the behavior stability index value of each vehicle 1 for each group based on the acquired behavior data (Step S114).

Thereafter, the data analysis unit 213 determines whether the index value indicating the behavior stability of the specific group satisfies the predetermined behavior stabilization condition (Step S115). At this time, when it is determined that the index value indicating the behavior stability of the specific group satisfies the behavior stabilization condition, the data analysis unit 213 causes the process to proceed to Step S116. When it is determined that the index value does not satisfy the behavior stabilization condition, the data analysis unit 213 causes the process to proceed to a process of Step S108.

Thereafter, the data analysis unit 213 executes the output condition identification process for identifying the sound effect output condition set for the specific group as the optimization output condition (Step S116), and ends the operation.

When the driver assistance based on the auditory stimulation on a predetermined driver is performed, the data provision processing unit 214 transmits the optimization sound effect output control data for performing the sound effect output control based on the optimization output condition identified in the process of Step S116 to the relevant information processing system 10.

Further, upon receiving the optimization sound effect output control data transmitted from the management server 20, the information processing system 10 of the predetermined driver reproduces the sound effect data based on the received optimization sound effect output control data, and outputs the predetermined sound effect into the vehicle 1 while the vehicle is traveling in the application section.

### [B1.6.2] Operation of Information Processing System

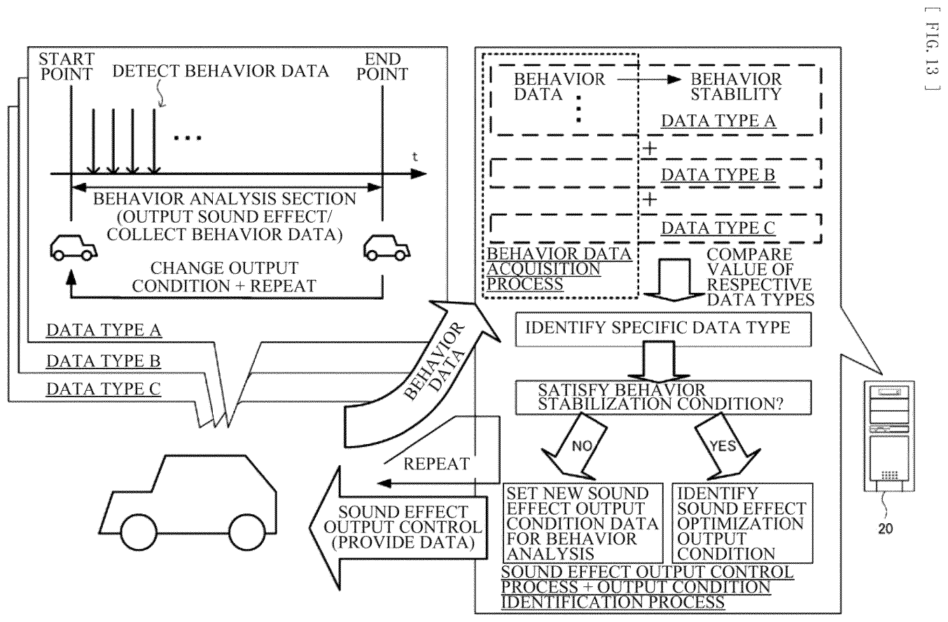

Next, an operation of the vehicle 1 relating to the sound effect optimization output condition identification process to be executed by the information processing system 10 of the present embodiment is described with reference to FIG. 12. FIG. 12 is a flowchart of an operation of the vehicle I relating to the sound effect optimization output condition identification process to be executed by the information processing system 10 according to the present embodiment.

In this operation, it is assumed that driving of the relevant vehicle 1 is started by a specific driver, and the information processing system 10 controls the output of a predetermined sound effect to perform the auditory stimulation while the vehicle 1 is traveling in a predetermined section.

First, when receiving the sound effect output control data for behavior analysis including the behavior analysis reference data transmitted from the management server 20 (Step S201), the output control unit 114 stores the sound effect output control data for behavior analysis in the memory 140 and waits for execution of the sound effect output control (Step S202).

Thereafter, when the start point or the start timing of the behavior analysis section is detected (Step S203), the output control unit 114 starts reproducing predetermined sound effect data based on the sound effect output control data for behavior analysis stored in the memory 140 (Step S204). When the reproduction of the sound effect data is started, the output control unit 114 causes the sound output device 19 to output the sound effect in accordance with the output condition during the reproduction of the sound effect data.

Thereafter, the data processing unit 113 instructs the vehicle behavior measurement device 11 to start detecting the behavior data, to thereby start collecting the behavior data (Step S205). When receiving the instruction to start detecting the behavior data, the vehicle behavior measurement device 11 detects the behavior data at predetermined timings and outputs the detected behavior data to the data processing unit 113 until an instruction to stop collecting the behavior data is issued.

Thereafter, when the end point or the end timing of the behavior analysis section is detected during the reproduction of the sound effect data (Step S206), the output control unit 114 stops reproducing the sound effect data based on the sound effect output control data for behavior analysis (Step S207).

Thereafter, the data processing unit 113 instructs the vehicle behavior measurement device Il to end the detection of the behavior data, to thereby stop collecting the behavior data (Step S208). Thereafter, the data processing unit 113 transmits the collected behavior data to the management server 20 via the communicator 170 under the control of the communication control unit 111 (Step S209), to thereby ends the present operation.

### [B1.7]

### [B1.7.1] Modification Example 1: Execution of Part or All of Sound Effect Optimization Output Condition Identification Process

Next, a modification example of the present embodiment is described. In the modification example, some or all of the processes relating to the sound effect optimization output condition identification process are performed.

In the present embodiment, some or all of the processes relating to the sound effect optimization output condition identification process may be executed by the information processing system 10 mounted in the vehicle 1 instead of the management server 20. Specifically, the information processing system 10 may be configured to execute some or all of the process for setting the sound effect output control data for behavior analysis including the behavior analysis reference data, the behavior data acquisition process, the sound effect output control process, and the output condition identification process.

In particular, when the behavior data is acquired from another information processing system 10 or when the sound effect output control data for behavior analysis is provided to the other information processing system 10, the information processing system 10 executes data transmission and reception with the other information processing system 10 via the management server 20. However, the information processing system 10 may be communicably and directly coupled to the other information processing system 10 via a network to execute the data transmission and reception.

Further, when the sound effect output control process is executed by the information processing system 10, the information processing apparatus 100 included in the information processing system 10 executes, as the sound effect output control process, a process for directly controlling the sound output device 19 based on the sound effect output control data for behavior analysis.

### [B1.7.2] Modification Example 2: Sound Effect Optimization Output Condition Identification Process Based on Driver Characteristic

Next, a description is given of the sound effect optimization output condition identification process based on a driver characteristic according to a modification example of the present embodiment.

### (Outline of Sound Effect Optimization Output Condition Identification Process Based on Driver Characteristic)

The management server 20 of the present embodiment may execute the sound effect optimization output condition identification process based on a predetermined driver characteristic. That is, the management server 20 executes an information acquisition process for acquiring information on a specific driver characteristic (hereinafter, referred to as “driver characteristic information”) from each information processing system 10 or the driver data memory unit 243. Thereafter, as the sound effect output condition identification process, the management server 20 may identify a provisional optimization output condition and a final optimization output condition based on the specific driver characteristic, In particular, the driver characteristic indicates a characteristic of driving intended by the driver who drives the vehicle 1, or a characteristic relating to the driving ability of the driver (hereinafter, referred to as “ability characteristic”). Further, for example, the driving characteristic includes a driving characteristic provided by an accelerating operation, a braking operation, a steering operation of the driver, or the like. The ability characteristic includes the difference in reaction speed in response to a sound, the difference in ability to learn driving, and the like.

With such a configuration, in the present modification example, it is possible to automatically identify the optimal output condition depending on the degrees of proficiency in driving of a beginner driver and a skilled driver, or the difference in individual ability such as the difference in reaction speed in response to a sound effect or the difference in ability to learn a driving skill in accordance with a sound effect.

In this modification example, it is preferable that the driver characteristic information be acquired before the output condition identification process is executed and that a group corresponding to the driver characteristic (the vehicle 1) whose behavior data is to be collected be selected in advance based on the driver characteristic information. However, as in the above-described embodiment, grouping may be performed in advance, the behavior data may be acquired in association with the driver characteristics, and the sound effect optimization output condition may be identified only based on the behavior data of the relevant driver characteristic in each group.

The predetermined driver characteristic may be a characteristic identified in advance by an application or the like, or may include two or more characteristics. The predetermined driver characteristic may be a characteristic of the driver that provides the sound effect optimization output condition, or may be a characteristic defined by the selection of the driver.

### (Information Acquisition Process for Acquiring Driver Characteristic Information)

The data acquisition unit 212 executes an information acquisition process for acquiring, as the driver characteristic information, the degree of proficiency in driving, a reaction speed in response to a sound effect, or the level of ability to learn a driving skill in accordance with a sound effect that are determined based on answers to questionnaires given from the information processing system 10 of the vehicle 1 to the driver, tests using sound effects, or a driving operation history of the vehicle 1, for example.

The data acquisition unit 212 may acquire, as the driver characteristic information, the degree of proficiency in driving of each driver, the reaction speed in response to a sound effect, or the ability to learn a driving skill in accordance with a sound effect that are preliminarily stored in the driver data memory unit 243 from the driver data memory unit 243.

Further, the acquisition of the driver characteristic includes acquiring, with the data acquisition unit 212, the answers to questionnaires given from the information processing system 10 to the driver, the results of the tests using the sound effects, or the driving operation history, and identifying the driver characteristic based on the acquired answers or the like.

For example, the data acquisition unit 212 identifies the driver characteristic of each driver based on the answers to the questionnaires given from the information processing system 10 to the driver or the like. Further, the data acquisition unit 212 may determine the level of the driving operation skill of the driver based on the number of years after the acquisition of a driver's license, the driving frequency in the past year, the driving time or the traveling distance, and the number of days since the last driving. Further, the data acquisition unit 212 may identify the level of the driving operation skill of the driver based on the behavior stability such as the cumulative value of the acceleration rate or the jerk, the number of times of excesses of the threshold, the number of times of correction operations, and the like, with reference to the driving operation history of the driver.

### (Output Condition Identification Process Based on Driver Characteristics)

The data analysis unit 213 determines the type of the driver characteristic for identifying the sound effect optimization output condition based on an instruction to execute the sound effect optimization output condition identification process and an input operation instruction, for example. Based on the determined driver characteristic, the data analysis unit 213 divides a plurality of drivers into groups, and selects groups for acquiring the behavior data having common driver characteristics and having the different sound effect output conditions. Further, the data analysis unit 213 executes, for each group, the output condition identification process for identifying the provisional sound effect output condition corresponding to the determined driver characteristic while executing the process for setting the behavior analysis reference data and the sound effect output control data for behavior analysis, and the sound effect output control process based thereon. Thereafter, when the repetitive execution result such as the behavior stability of a specific group satisfies the behavior stabilization condition, the data analysis unit 213 identifies the output condition corresponding to the repetitive execution result as the sound effect optimization output condition.

The data acquisition unit 212 acquires the respective pieces of the behavior data collected based on the sound effect output control data for behavior analysis including the behavior analysis reference data, as in the above-described embodiment.

### [B1.7.3] Modification Example 3: Sound Effect Optimization Output Condition Identification Process Based on Traveling Environment

Next, a description is given of the sound effect optimization output condition identification process based on the traveling environment of the vehicle 1 according to a modification example of the present embodiment.

### (Outline of Sound Effect Optimization Output Condition Identification Process Based on Traveling Environment of Vehicle)

The management server 20 of the present embodiment may execute the sound effect optimization output condition identification process for a predetermined traveling environment. That is, the management server 20 may execute an information acquisition process for acquiring information on a traveling environment (hereinafter, referred to as “traveling environment information”) from each information processing system 10, and identify an optimization output condition for a predetermined traveling environment as the sound effect optimization output condition identification process.

In particular, the traveling environment refers to a traffic environment such as an environment in which many pedestrians or bicycles are present, an environment in which oncoming vehicles or obstacles are present, a heavy traffic environment, or an environment with a high danger of accidents; a road environment such as a school road in a school time zone, a road shape, or a large or narrow road width; and weather such as sunny, rainfall, or snowfall weather.

With such a configuration, the management server 20 of the present modification example makes it possible to automatically identify the sound effect output condition that stabilizes the vehicle behavior in accordance with the traveling environment.

In this modification example, it is preferable that the traveling environment for identifying the sound effect optimization output condition be determined in advance in accordance with an instruction from the driver or an instruction from an application. Accordingly, in the present modification example, it is preferable to extract the behavior data of the driver having traveled in the same traveling environment as a set traveling environment from the drivers in the respective groups selected in advance, and to identify the sound effect optimization output condition based on the extracted behavior data, as in the present embodiment.

The predetermined traveling environment may include two or more traveling environments. The predetermined traveling environment may be a traveling environment in which the driver to which the sound effect optimization output condition is provided is likely to travel from now on, or may be a traveling environment determined by the selection of the driver.

### (Information Acquisition Process for Acquiring Traveling Environment Information and Data Acquisition Process for Acquiring Behavior Data)

The data acquisition unit 212 acquires the behavior data and the traveling environment information from the information processing systems 10 of the vehicles 1, and performs, for each group, labeling of the acquired behavior data according to the type of the traveling environment preliminarily determined.

Specifically, the data acquisition unit 212 acquires, as the traveling environment information, surrounding environment information indicating a surrounding condition of the vehicle 1 such as a road width, or the weather information (the weather condition information or the weather reception information) indicating the presence or absence of rainfall, the amount of rainfall, or the condition of wind. Further, the data acquisition unit 212 refers to a map of an area where many pedestrians or bicycles are present or a heavy traffic area to acquire position information including information indicating the environment of a current traveling area from the information processing system 10 of the vehicle 1. For example, the position information indicates that the current position is located in the area where many pedestrians or bicycles are present.

In addition, when the labeling of the acquired behavior data is performed for each group, the data acquisition unit 212 outputs the groups labeled with the respective types of the traveling environments to the data analysis unit 213. Note that the data acquisition unit 212 may acquire the behavior data already labeled with the traveling environment from the information processing system 10. In this case, the information processing apparatus 100 of the information processing system 10 performs the labeling of the collected behavior data according to the types of the traveling environments preliminarily determined based on the types of the traveling environments preliminarily determined.

Further, the data acquisition unit 212 may acquire the behavior data preliminarily labeled with the type of the traveling environment from the information processing system 10. In this case, the information processing system 10 performs the labeling according to the types of the traveling environments at the time of collection of the behavior data. Further, in this case, each piece of the behavior data includes traveling environment type information indicating the type of the labeled traveling environment.

### (Sound Effect Optimization Output Condition Identification Process Based on Traveling Environment)

The data analysis unit 213 determines the type of the traveling environment for identifying the sound effect optimization output condition based on the instruction to execute the identification process, the input operation instruction, and the like. As in the first embodiment, the data analysis unit 213 executes the process for setting the behavior analysis reference data and the sound effect output control data for behavior analysis, and the sound effect output control process based thereon, for each selected group, in conjunction with the data acquisition unit 212. In particular, based on the behavior data labeled with the determined traveling environment, the data analysis unit 213 executes the process for setting the sound effect output control data for behavior analysis, and the sound effect output control process based thereon.

In addition, the data analysis unit 213 repeats the process for setting the sound effect output control data for behavior analysis and the sound effect output control process based thereon while the data acquisition unit 212 is executing the behavior data acquisition process, and executes the identification process for identifying the provisional sound effect output condition corresponding to the determined traveling environment. Thereafter, when the repetitive execution result such as the behavior stability of the identified group satisfies the behavior stabilization condition, the data analysis unit 213 identifies the output condition corresponding to the repetitive execution result as the sound effect optimization output condition

### [B.1.7.4] Modification Example 4: Restart of Sound Effect Optimization Output Condition Identification Process

Next, a description is given of a restart of the sound effect optimization output condition identification process according to a modification example of the present embodiment.

### (Case Where Better Behavior Stability is Obtained)

While the sound effect output control based on the optimization sound effect output control data is executed, the management server 20 according to the present embodiment may restart the output condition identification process when behavior stability higher than the behavior stability obtained based on the output condition is detected.

That is, when the result (i.e., the sound effect output condition of the specific group) of processes such as the behavior data acquisition process and the like repeatedly executed satisfies the preset behavior stabilization condition in the sound effect optimization output condition identification process, the management server 20 stops the behavior data acquisition process and the like. In addition, as an output condition fixing control process, the management server 20 fixes the sound effect output condition to the optimal output condition (i.e., the sound effect optimization output condition) identified when the behavior data acquisition process and the like are stopped, and executes control for performing the auditory stimulation on the driver. Thereafter, when the behavior data is acquired based on the output condition fixing control process and the behavior stability retrieved from the acquired behavior data satisfies a given first particular output condition, the management server 20 restarts the sound effect optimization output condition identification process.

Specifically, when the sound effect optimization output condition is identified, the data analysis unit 213 provides the sound effect output control data based on the optimization output condition (the optimization sound effect output control data) to the information processing system 10 of the relevant vehicle 1, as the output condition fixing control process.

Further, the data acquisition unit 212 acquires the latest behavior stability of the vehicle 1 from a non-illustrated database or the like, and stores the latest behavior stability in the driver data memory unit 243. Thereafter, the data analysis unit 213 calculates the index value indicating the behavior stability of the vehicle 1 from the behavior data based on the sound effect optimization output condition acquired from the information processing system 10, and compares the calculated index value with the acquired latest behavior stability. Thereafter, when the first particular output condition, i.e., the condition that the latest behavior stability is higher than the behavior stability of the calculated index value is satisfied, the data analysis unit 213 restarts the sound effect optimization output condition identification process.

For example, used as the latest behavior stability of the vehicle 1 is the behavior stability obtained in the sound effect optimization output condition identification process executed at a timing, such as the latest timing, different from the timing at which the behavior stability index value to be compared is calculated. Alternatively, for example, used as the latest behavioral stability of the vehicle 1 may be the behavior stability obtained in the sound effect optimization output condition identification process executed on a vehicle or a group different from the vehicle whose index value is calculated for comparison or the group to which the vehicle belongs.

When the sound effect optimization output condition identification process is restarted, the behavior data acquisition process and the output condition identification process including resetting the sound effect output control data for behavior analysis are repeatedly executed. In particular, in this case, since the behavior data acquisition process and the output condition identification process including resetting the effect sound effect output control data for behavior analysis are the same as those in the above-described embodiment, the descriptions thereof are omitted. However, in this case, it is preferable to use a condition different from the behavior stabilization condition before the restart.

Further, in the present modification example, unlike the above, the sound effect optimization output condition identification process may be restarted based on an instruction from an application or based on an operation instruction from the driver or the like. For example, in this case, the data analysis unit 213 restarts the sound effect optimization output condition identification process when a predetermined period of time has elapsed from the date and time of storing the optimization output condition, when the driver characteristic has changed, or when the traveling environment has changed.

### (Case Where Behavior Stability Based on Sound Effect Optimization Output

Condition Decreases) When a decrease in the behavior stability based on the sound effect optimization output condition is detected while the sound effect output control based on the optimization sound effect output control data is executed, the management server 20 according to the present embodiment may restart the output condition identification process.

In particular, when the behavior stability retrieved from the behavior data collected based on the output condition fixing control process satisfies a given second particular output condition, the management server 20 determines that the behavior stability based on the sound effect optimization output condition has decreased, and restarts the sound effect optimization output condition identification process.

Specifically, when the sound effect optimization output condition identification process is restarted, the data analysis unit 213 provides the sound effect output control data (the optimization sound effect output control data) based on the optimization output condition to the information processing system 10 of the relevant vehicle 1, as the output condition fixing control process, as in the modification example described above.

Further, the data acquisition unit 212 stores the behavior stability based on the sound effect optimization output condition in the driver data memory unit 243. Thereafter, the data analysis unit 213 calculates the index value indicating the behavior stability of the vehicle 1 based on the behavior data acquired from the information processing system 10, and compares the calculated index value with the stored behavior stability. Thereafter, the data analysis unit 213 restarts the output condition identification process when the second particular output condition that the behavior stability indicated by the calculated index value is less than the behavior stability stored is satisfied.

When the sound effect optimization output condition identification process is restarted, the behavior data acquisition process and the output condition identification process including resetting the sound effect output control data for behavior analysis are repeatedly executed. In particular, in this case, since the behavior data acquisition process and the output condition identification process including resetting the sound effect output control data for behavior analysis are the same as those in the above-described embodiment, the descriptions thereof are omitted. However, in this case, it is preferable to use a condition different from the behavior stabilization condition before the restart.

### [B1.7.5] Other Modification Examples

In the present embodiment, the sound effect optimization output condition is provided to a specific driver; however, the sound effect optimization output condition may be shared by a plurality of drivers including other drivers.

In the present embodiment, the index value indicating the behavior stability of the specific group is used as the repetitive execution result in the output condition identification process; however, the repetitive execution result may be the number of times of the output condition identification process.

Further, in the present embodiment, the stabilization condition may be satisfied when the behavior stability converges to a specific value by repeatedly executing the behavior data acquisition process or the like, and the output condition at that time may be identified as the optimization output condition. In this case, the convergence may be detected not only when the behavior stability converges to a specific output condition, but also when a plurality of times of switching of the identified group at that time is detected.

### [B2] Second Embodiment

### [B2.1] Driver Assistance Network System

Next, an outline of the driver assistance network system S of the present embodiment and an outline of the sound effect optimization output condition identification process of the present embodiment are described with reference to FIG. 13. FIG. 13 is a diagram for describing the sound effect optimization output condition identification process according to the present embodiment.

The driver assistance network system S of the present embodiment is characterized in that the optimization condition identification process for identifying the sound effect optimization output condition is executed only based on the behavior data of a specific driver. That is, unlike the driver assistance network system S of the first embodiment that identifies the sound effect optimization output condition based on the behavior data of the plurality of drivers, the driver assistance network system S of the present embodiment identifies the sound effect optimization output condition based only on the behavior data of the individual driver. Note that the management server 20 of the present embodiment is configured to execute processing relating to such a feature point.

In particular, as illustrated in FIG. 13, the management server 20 of the present embodiment executes the behavior data acquisition process for acquiring the behavior data collected based on each type (i.e., data type) of the sound effect output control data for behavior analysis including the behavior analysis reference data in one specific vehicle 1. For example, as illustrated in FIG. 13. the management server 20 executes the behavior data acquisition process after the vehicle 1 passes through the predetermined section. In addition, as illustrated in FIG. 13, when acquiring the respective pieces of the behavior data, the management server 20 sets new sound effect output control data for behavior analysis having the different output conditions for each data type based on the acquired behavior data of various data types. Thereafter, as illustrated in FIG. 13, as the sound effect output control process, the management server 20 provides the newly set sound effect output control data for behavior analysis to the information processing system 10 of the specific vehicle 1, and executes the behavior data acquisition processing of acquiring respective pieces of the behavior data, and repeats these processes.

Further, as illustrated in FIG. 13, as the output condition identification process, the management server 20 compares the behavior stability of each data type retrieved from the behavior data to identify the provisional sound effect optimization output condition and identify the data type for which the output condition is set. Thereafter, as illustrated in FIG. 13, the management server 20 executes a determination process for determining whether the sound effect output condition of the specific data type satisfies a predetermined behavior stabilization condition. At this time, when it is determined in the determination process that the provisional optimal output condition of the specific data type satisfies the behavior stabilization condition, the management server 20 identifies the output condition as the sound effect optimization output condition.

As in the first embodiment, the management server 20 is configured to execute the output condition identification process while repeatedly executing the sound effect output control and the behavior data acquisition process based thereon with changing the sound effect output condition and the data type of the sound effect, and eventually identify the sound effect optimization output condition.

As illustrated in FIG. 13, after the vehicle passes through the behavior analysis section, each information processing system 10 collects the behavior data indicating the behavior of the vehicle based on the sound effect reproduced while the vehicle is traveling in the behavior analysis section, and provides the collected behavior data to the management server 20.

When the sound effect optimization output condition is identified as described above, the management server 20 provides the optimization sound effect output control data to the information processing system 10 as illustrated in FIG. 13. Thereafter, as illustrated in FIG. 13, the information processing system 10 reproduces the sound effect data based on the sound effect optimization output control data to output a predetermined sound effect into the vehicle 1 in the application section.

With such a configuration, the management server 20 or the driver assistance network system S including the management server 20 of the present embodiment makes it possible to automatically identify the output condition optimal for the driver, such as the optimal output timing, the optimal sound type, or the optimal tone color of the sound effect to enhance the behavior stability, as in the first embodiment.

Accordingly, the driver assistance system of the present embodiment makes it possible to appropriately stimulate the auditory sense of the driver to enhance the behavior stability by simply providing the sound effect output condition automatically identified to the driver.

Since the driver assistance network system S of the present embodiment has the same configuration as that of the first embodiment except for the feature point described above, the same components are denoted by the same reference numerals to omit the description thereof. In the following description, differences from the first embodiment are mainly described. In particular, the configuration and operation of the information processing system 10 of the present embodiment are similar to those of the first embodiment except that a plurality of different pieces of the sound effect output control data for behavior analysis are used, and thus the description thereof is omitted.

### [B2.2] Data Acquisition Process and Sound Effect Output Control Process

Next, a description is given of the data acquisition process including setting the sound effect output control data for behavior analysis and the sound effect output control process that are executed by the management server 20 of the present embodiment.

### (Data Acquisition Process and Sound Effect Output Control Process)

Unlike the first embodiment, the management server 20 of the present embodiment repeatedly executes the data acquisition process including setting the sound effect output control data for behavior analysis and the sound effect output control process for the individual driver, and executes the output condition identification process for identifying the provisional sound effect output condition.

Specifically, as in the first embodiment, the data analysis unit 213 sets, as the reference data for behavior analysis, multiple pieces of the sound effect output control data for behavior analysis each defining a predetermined sound effect output condition, where the sound effect output conditions are different from each other.

The data provision processing unit 214 provides the behavior analysis reference data having the different output conditions to each of the information processing systems 10 mounted in the vehicles 1 driven by the same driver. Thereafter, the data acquisition unit 212 acquires the behavior data collected based on the respective pieces of the behavior analysis reference data, as the data acquisition process.

Further, the data analysis unit 213 calculates the behavior stability index value based on each piece of the behavior data, and sets the sound effect output control data for behavior analysis having a new output condition based on the index value calculated for each type of the behavior analysis reference data.

Thereafter, the data provision processing unit 214 provides the information processing system 10 of the same driver with the sound effect output control data for behavior analysis including the data on the new output condition to, as the sound effect output control process. That is, the data provision processing unit 214 provides the sound effect output control data for behavior analysis to the information processing system 10, thereby causing the information processing system 10 to control the sound effect output based on the respective pieces of the sound effect output control data for behavior analysis.

As in the first embodiment, there is no change in the sound effect output control data for behavior analysis having the provisional optimization output condition, and the data provision processing unit 214 may thus control the sound effect output based on the sound effect output control data for behavior analysis having the provisional optimization output condition that has already been provided.

In addition, as in the first embodiment, when the sound effect output control data for behavior analysis having the provisional optimization output condition is not changed, the data provision processing unit 214 may control the sound effect output based on the sound effect output control data for behavior analysis that has been already provided to the information processing system 10.

### (Processing in Information Processing System)

When the behavior data is collected based on multiple pieces of the sound effect output control data for behavior analysis including the behavior analysis reference data and having the different output conditions, the information processing system 10 executes the sound effect output control based on the sound effect output control data for behavior analysis at different collecting timings. Further, when the behavior data are collected, the information processing system 10 acquires the behavior data to which the ID or the name of the used sound effect output control data for behavior analysis is assigned.

### (Case Where Number of Pieces of Behavior Data is Insufficient)

When the number of pieces of the behavior data acquired in the data acquisition process is insufficient, the data analysis unit 213 may cause the information processing system 10 to execute a process for acquiring additional pieces of the behavior data.

In particular, in a case where the behavior data based on the different sound effect output control conditions are acquired from an individual driver, it is difficult to secure a sufficient number of pieces of the data in a short time as compared with a case where the behavior data are acquired from a plurality of drivers. Therefore, the shortage of the number of pieces of the behavior data often makes it difficult for the driver to accurately identify the sound effect optimization output condition for stabilizing the behavior of the vehicle 1, and, as a result, makes it difficult to sufficiently stabilize the behavior of the vehicle 1 even though the driver assistance is performed using the sound effect.

Therefore, when the number of the behavior data is insufficient when the provisional sound effect output condition is identified, the data analysis unit 213 of the present embodiment may execute the process for acquiring additional pieces of the behavior data.

Specifically, when the sound effect output control data for behavior analysis is set, the data analysis unit 213 detects the number of pieces of the behavior data for each type of the behavior analysis reference data. Further, the data analysis unit 213 determines whether the number of pieces of the behavior data satisfies a predetermined numerical condition for each type of the behavior analysis reference data. For example, the data analysis unit 213 determines whether the number of pieces of the behavior data for each type of the behavior analysis reference data is greater than or equal to a certain number.

At this time, when it is determined that the number of pieces of the behavior data does not satisfy the numerical condition in at least one type of the sound effect output control data for behavior analysis, the data analysis unit 213 instructs the information processing system 10 to collect additional pieces of the behavior data of the relevant type of the sound effect output control data for behavior analysis. In addition, for the type of the sound effect output control data for behavior analysis that satisfies the above-described numerical condition, the data analysis unit 213 sets the sound effect output control data for behavior analysis without collecting additional pieces of the behavior data, as described above.

When the instruction to collect additional pieces of the behavior data is issued, the information processing system 10 collects additional pieces of the behavior data with respect to the relevant type of the sound effect output control data for behavior analysis.

In contrast, when it is determined that the number of pieces of the behavior data does not satisfy the above-described numerical condition in at least one type of the sound effect output control data for behavior analysis, the data analysis unit 213 may execute a process for correcting the behavior stability retrieved from the behavior data that has been already acquired.

In this case, if each piece of the behavior data is labeled according to the type of the traveling environment, the data analysis unit 213 makes it possible to correct each piece of the behavior data or the behavior stability retrieved from each piece of the behavior data based on the labeling with respect to the type of the sound effect output control data for behavior analysis whose number of pieces is small.

For example, since the behavior stability of the vehicle 1 in rainfall weather is often lower than the behavior stability of the vehicle 1 in sunny weather, the data analysis unit 213 corrects the value of the behavior stability to a value higher than that in the behavior data acquired at the time of sunny weather.

### [B2.3] Operation of Present Embodiment (Operation of Management Server)

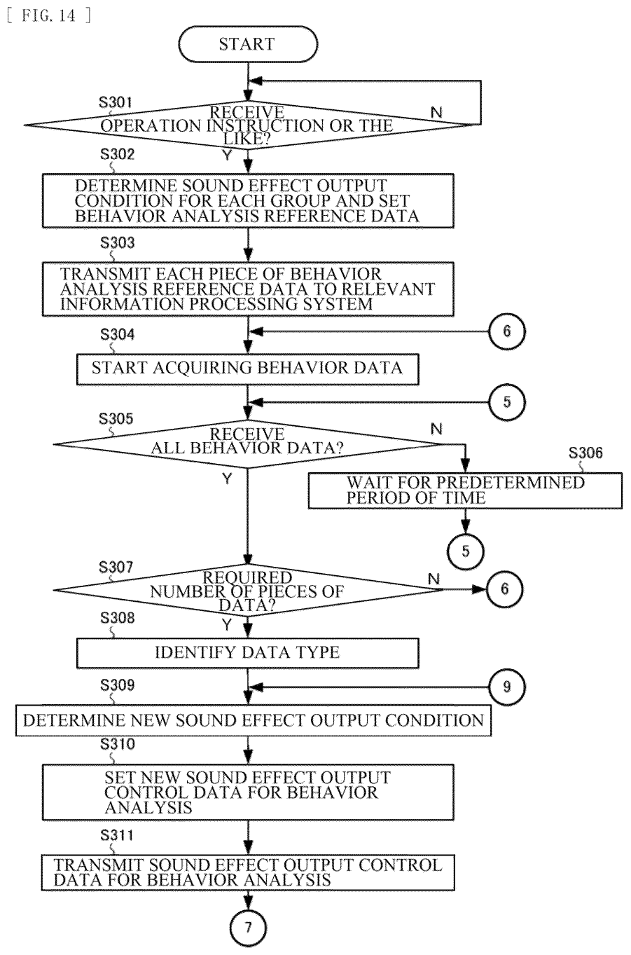

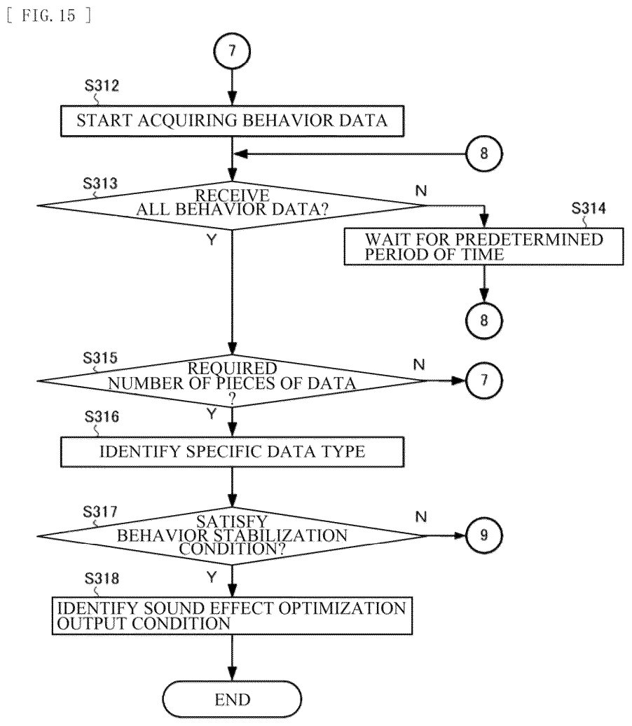

Next, the operation of the sound effect optimization output condition identification process to be executed by the management server 20 of the present embodiment is described with reference to FIGS. 14 and 15, FIGS. 14 and 15 are flowcharts illustrating the operation of the sound effect optimization output condition identification process to be executed by the management server 20 of the present embodiment.

The operation is executed with respect to only one driver (i.e., a specific driver) and the information processing system 10 mounted in the vehicle 1 driven by the driver. Further, in the present operation, it is assumed that the relevant vehicle 1 is driven by the specific driver, and that the output of a predetermined sound effect is controlled by the information processing system 10 upon the auditory stimulation while the vehicle 1 is traveling in the predetermined section.

First, when receiving an instruction, such as an operation instruction from the specific driver or an instruction from an application, to execute the sound effect optimization output condition identification process (Step S301), the data analysis unit 213 sets a predetermined number of pieces of the behavior analysis reference data to be provided to the specific driver (Step S302).

Thereafter, the data provision processing unit 214 transmits the set behavioral analysis reference data to the information processing system 10 of the vehicle 1 driven by the specific driver (Step S303). The data provision processing unit 214 may transmit the behavior analysis reference data to the information processing system 10 of the vehicle 1 driven by another driver, or may set the information processing system 10 to which the behavior analysis reference data is to be transmitted in accordance with a rule determined in advance by an application or the like.

Thereafter, the data acquisition unit 212 starts acquiring the behavior data transmitted from the information processing system 10 (Step S304). In particular, the data acquisition unit 212 may receive all the behavior data groups obtained in the predetermined section for each piece of the behavior analysis reference data at a time, or may receive each piece of the behavior data.

Thereafter, the data acquisition unit 104 determines whether all the pieces of the behavior data based on the respective pieces of the behavior analysis reference data have been received after passing through the predetermined section (Step S305). At this time, when it is determined that all the pieces of the behavior data based on the respective pieces of the behavior analysis reference data have been received after passing through the predetermined section, the data acquisition unit 204 causes the process to proceed to Step S307. When it is determined that all the pieces of behavioral data have not been received, the data acquisition unit 204 waits for a predetermined period of time (Step S306), and executes the process of Step S305 again.

Thereafter, the data acquisition unit 104 determines, for each piece of the behavior analysis reference data, whether the number of pieces of the acquired behavior data is a required number of pieces of data (Step S307). At this time, when it is determined that the number of pieces of the behavior data is greater than or equal to the required number of pieces of data, the data acquisition unit 104 causes the process to proceed to Step S308. When it is determined that the number of pieces of the behavior data is less than or equal to the required number of pieces of data, the data acquisition unit 104 causes the process to proceed to Step S304.

The data acquisition unit 104 may simply determine whether the number of pieces of the acquired behavior data is greater than or equal to the required number of pieces of data. Further, the data acquisition unit 104 may select valid behavior data usable for the stability analysis based on information on the labeling of the traveling environments (i.e., labeling information) or the driver characteristic information, and determine whether the number of pieces of the selected valid behavior data is greater than or equal to the required number of pieces of data. In particular, the data acquisition unit 104 selects, as invalid behavior data, behavior data obtained in a specific environmental such as an environment in a rainy time or an environment where many pedestrians or bicycles are present.

Thereafter, the data analysis unit 213 calculates the index value indicating the behavior stability of the vehicle 1 for each type (i.e., data type) of the behavior analysis reference data based on the acquired behavior data, and identifies the data type having the index value of optimal behavior stability from among the plurality of data types (Step S308).

Thereafter, the data analysis unit 213 determines the sound effect output condition set for the specific reference data as the provisional sound effect optimization output condition, and determines the sound effect output condition for analyzing next behavior stability based on the determined provisional sound effect optimization output condition (Step S309). Note that the data analysis unit 213 determines the output conditions that is smaller in number by “1” than the predetermined number described above. Specifically, the data analysis unit 213 determines the output conditions for a plurality of sound effects except for the provisional sound effect optimization output condition.

Thereafter, the data analysis unit 213 sets, based on the respective output conditions, including the provisional sound effect optimization output condition, determined in the process of Step S308, new sound effect output control data for behavior analysis smaller in number by “1” than the predetermined number described above (Step S310).

Thereafter, the data provision processing unit 214 transmits the set sound effect output control data for behavior analysis to the respective information processing systems 10 of the relevant vehicles 1 (Step S311).

Thereafter, the data acquisition unit 212 starts acquiring the behavior data transmitted from the respective information processing systems 10 as in Step S304 (Step S312).

Thereafter, as in the process of Step S305, the data acquisition unit 104 determines whether all the pieces of behavior data based on the respective pieces of the behavior analysis reference data have been received after passing through the predetermined section (Step S313). At this time, when it is determined that all the pieces of behavior data based on the respective pieces of the sound effect output control data for behavior analysis have been received after passing through the predetermined section, the data acquisition unit 204 causes the process to proceed to a process of S314. When it is determined that all the pieces of the behavior data have not been received, the data acquisition unit 204 executes the process of Step S312 again after the lapse of a predetermined time (Step S314).

Thereafter, the data acquisition unit 104 determines, for each piece of the behavior analysis reference data, whether the number of pieces of the acquired behavior data is the required number of pieces of data (Step S315). At this time, when it is determined that the number of pieces of the behavior data is greater than or equal to the required number of pieces of data, the data acquisition unit 104 causes the process to proceed to Step S316. When it is determined that the number of pieces of the behavior data is less than or equal to the required number of pieces of data, the data acquisition unit 104 causes the process to proceed to Step S302.

Thereafter, as in Step S308, the data analysis unit 213 calculates the index value indicating the behavior stability of the vehicle 1 for each data type based on the acquired behavior data, and identifies a specific data type (Step S316).

Thereafter, the data analysis unit 213 determines whether the index value indicating the behavior stability of the specific data type satisfies a predetermined behavior stabilization condition (Step S317). At this time, when it is determined that the index value of the behavior stability of the specific data type satisfies the behavior stabilization condition, the data analysis unit 213 causes the process to proceed to Step S318. In contrast, when it is determined that the index value does not satisfy the behavior stabilization condition, the data analysis unit 213 causes the process to proceed to Step S309.

Thereafter, the data analysis unit 213 identifies the sound effect output condition set for the specific sound effect output control data for behavior analysis as the optimization output condition (Step S318), and ends this operation.

When the driver assistance based on the auditory stimulation on a predetermined driver is performed, the data provision processing unit 214 transmits the optimization sound effect output control data for performing the sound effect output control based on the optimization output condition identified in the process of Step S318 to the relevant information processing system 10.

Further, upon receiving the optimization sound effect output control data transmitted from the management server 20, the information processing system 10 of the predetermined driver reproduces the sound effect data based on the received optimization sound effect output control data, and outputs the predetermined sound effect into the vehicle 1 while the vehicle 1 is traveling in the application section.

### [B2.4] Modification Example

The present embodiment may be applied to various modification examples as for the case of the first embodiment. Therefore, the description of each modification example is omitted.

### [C] Others

The embodiments of the disclosure are not limited to those described in the above embodiments, and various modifications may be made. For example, the terms used as broad or synonymous terms in one description of the specification or the drawings may be replaced with the broad or synonymous terms in the other descriptions of the specification or the drawings.

Embodiments of the disclosure include configurations substantially the same as the configurations described in the above embodiments (for example, configurations having the same function, method, and result, or configurations having the same purpose and effect). Further, embodiments of the disclosure include configurations in which non-essential portions of the configurations described in the above embodiments are replaced. Further, embodiments of the disclosure include configurations that achieve the same operations and effects, or configurations that achieve the same object as the configurations described in the above embodiments. Further, embodiments of the disclosure include configurations in which known techniques are added to the configurations described in the above embodiments.

Although embodiments of the disclosure have been described in detail above, those skilled in the art would readily appreciate that many variations are substantially possible without departing from the new matter and effect of the invention. Accordingly, all of these modifications are intended to be included within the scope of the embodiments of the present disclosure.

### DESCRIPTION OF REFERENCE NUMERALS

S: Driver assistance network system
1: Vehicle
10: Information processing system
11: Vehicle behavior measurement device
13: Vehicle surrounding condition detector
15: Weather information detector
17: Vehicle position information detector
19: Sound output device
20: Management server
40: Vehicle control apparatus
100: Information processing apparatus
104: Data acquisition unit
110: Processor
Ill: Communication control unit
112: Input reception processing unit
113: Data processing unit
114: Output control unit
119: Timer management unit
120: Operation input unit
122: Detection unit
140: Memory
141: Main memory unit
142: Data memory unit
150: Information storage medium
170: Communicator
204: Data acquisition unit
210: Processor
211: Communication control unit
212: Data acquisition unit
213: Data analysis unit
214: Data provision processing unit
219: Timer management unit
240: Memory
241: Main memory unit
242: Data memory unit
243: Driver data memory unit
250: Information storage medium
270: Communicator

1. A driver assistance system configured to assist a driver who drives a vehicle, the driver assistance system comprising:
one or more processors; and
one or more memories communicably coupled to the one or more processors, wherein
the one or more processors are configured to
execute a data acquisition process including acquiring data indicating a behavior of the vehicle as behavior data while the vehicle is traveling at least in a predetermined section,
execute, after the vehicle passes through the predetermined section, a sound effect output control process including performing control to stimulate an auditory sense of the driver by outputting a sound effect corresponding to behavior stability retrieved from the behavior data obtained in the predetermined section,
execute the data acquisition process and the sound effect output control process repeatedly while changing an output condition of the sound effect, and execute, when a result of the data acquisition process and the sound effect output control process repeatedly executed satisfies a setting condition set in advance, an identification process including identifying the output condition corresponding to the result as an optimal output condition.

2. The driver assistance system according to claim 1, wherein
the one or more processors are configured to
execute an information acquisition process including acquiring driver characteristic information indicating characteristics of the driver, and
identify the optimal output condition for a predetermined one of the characteristics of the driver in the identification process.

3. The driver assistance system according to claim 1, wherein
the one or more processors are configured to
execute an information acquisition process including acquiring information on traveling environments of the vehicle, and
identify the optimal output condition for a predetermined one of the traveling environments in the identification process.

4. The driver assistance system according to claim 1, wherein the output condition includes one or more of an output timing, a number of times of outputs, a tone color, a volume, a length, and a tempo of the sound effect.

5. The driver assistance system according to claim 1, wherein the one or more processors are configured to
stop the sound effect output control process and the data acquisition process in the identification process when the result of the data acquisition process and the sound effect output control process repeatedly executed is determined to satisfy the setting condition set in advance,
execute, when the sound effect output control process and the data acquisition process are stopped, an output condition fixing control process including executing the control to stimulate the auditory sense of the driver with fixing the output condition of the sound effect to the optimal output condition identified,
acquire the behavior data based on the output condition fixing control process, and
restart the identification process when the behavior stability retrieved from the behavior data acquired satisfies a given particular output condition.

6. The driver assistance system according to claim 5, wherein, the one or more processors are configured to use, when the identification process is restarted, a setting condition different from the setting condition set before restarting the identification process.

7. The driver assistance system according to claim 1, wherein, the one or more processors are configured to execute, when a number of pieces of the behavior data acquired in the data acquisition process is insufficient, control to acquire additional pieces of the behavior data or a process including correcting the behavior stability retrieved from the behavior data that has been already acquired.

8. A vehicle comprising a driver assistance apparatus that assists driving of the vehicle, the driver assistance apparatus being configured to
execute a data acquisition process including acquiring data indicating a behavior of the vehicle as behavior data while the vehicle is traveling at least in a predetermined section,
execute, after the vehicle passes through the predetermined section, a sound effect output control process for performing control to stimulate an auditory sense of the driver by outputting a sound effect corresponding to behavior stability retrieved from the behavior data obtained in the predetermined section,
execute the data acquisition process and the sound effect output control process repeatedly while changing an output condition of the sound effect, and
execute, when a result of the data acquisition process and the sound effect output control process repeatedly executed satisfies a setting condition set in advance, an identification process including identifying the output condition corresponding to the result as an optimal output condition.

9. A recording medium recording a computer program to be applied to a driver assistance system that assists driving of a vehicle, the computer program causing a computer to
execute a data acquisition process including acquiring data indicating a behavior of the vehicle as behavior data while the vehicle is traveling at least in a predetermined section,
execute, after the vehicle passes through the predetermined section, a sound effect output control process including performing control to stimulate an auditory sense of a driver by outputting a sound effect corresponding to behavior stability retrieved from the behavior data obtained in the predetermined section,
execute the data acquisition process and the sound effect output control process repeatedly while changing an output condition of the sound effect, and
execute, when a result of the data acquisition process and the sound effect output control process repeatedly executed satisfies a setting condition set in advance, an identification process including identifying the output condition corresponding to the result as an optimal output condition.

10. A driver assistance method of assisting driving of a vehicle, the driver assistance method comprising:
acquiring data indicating a behavior of the vehicle as behavior data while the vehicle is traveling at least in a predetermined section;
executing, after the vehicle passes through the predetermined section, a sound effect output control process including performing control to stimulate an auditory sense of the driver by outputting a sound effect corresponding to behavior stability retrieved from the behavior data obtained in the predetermined section;
executing the data acquisition process and the sound effect output control process repeatedly while changing an output condition of the sound effect; and
executing, when a result of the data acquisition process and the sound effect output control process repeatedly executed satisfies a setting condition set in advance, an identification process including identifying the output condition corresponding to the result as an optimal output condition.
